(19) United States
(12) Patent Application Publication
(10) Pub. No.: US 2015/0284544 A1
(43) Pub. Date: Oct. 8, 2015

(54) Mineral composition

(71) Applicants: Robert H Whitaker, Cleveland, GA (US); Dennis R Coburn, Franklin, TN (US)

(72) Inventors: Robert H Whitaker, Cleveland, GA (US); Dennis R Coburn, Franklin, TN (US)

(21) Appl. No.: 14/545,281

(22) Filed: Apr. 16, 2015

Related U.S. Application Data
(63) Continuation-in-part of application No. 13/066,571, filed on Apr. 18, 2011.
Application No. 13/066,571 is a continuation-in-part of application No. 12/657,528, filed on Jan. 22, 2010, now Pat. No. 8,771,826.
Application No. 12/657,528 is a continuation-in-part of application No. 11/999,205, filed on Dec. 4, 2007, now Pat. No. 7,651,559.
Application No. 11/999,205 is a continuation-in-part of application No. 11/638,618, filed on Dec. 13, 2006, now abandoned.
Application No. 11/638,618 is a continuation-in-part of application No. 11/266,833, filed on Nov. 4, 2005, now abandoned.
Application No. 13/066,571 is a continuation-in-part of application No. 12/927,442, filed on Nov. 15, 2010, now abandoned.
Application No. 12/927,442 is a continuation-in-part of application No. 11/405,966, filed on Apr. 18, 2006, now Pat. No. 7,833,339.

(51) Int. Cl. C08K 9/04

(52) U.S. Cl. CPC C08K 9/04

(57) ABSTRACT

A mineral composition comprised of at least 90 weight percent of roofing granules, wherein said roofing granules comprise at least 40 weight percent of calcium carbonate, have a hardgrove grindability index of less than 70, contain less than 1.0 percent of particles smaller than 250 microns, contain less than 1.0 percent of particles greater than 2380 microns, contain from about 2 to about 10 percent of particles greater than 1,680 microns, contain less than 2 percent of particles less than 40 microns, and have a Hunter L value of from about 20 to about 30.

### CROSS-REFERENCE TO RELATED PATENT APPLICATION

This patent application is a continuation-in-part of applicant's copending patent application U.S. Ser. No. 13/066,571, filed on Apr. 18, 2011, which in turn was a continuation-in-part of copending patent application U.S. Ser. No. 12/657,528, filed on Jan. 22, 2010, which in turn was a continuation-in-part of U.S. Ser. No. 11/999,205, filed on Dec. 4, 2007, now U.S. Pat. No. 7,651,559, which in turn was a continuation-in-part of patent application Ser. No. 11/638,618, filed on Dec. 13, 2006, now abandoned, which in turn was a continuation-in-part of patent application Ser. No. 11/266,833, filed on Nov. 4, 2005, now abandoned. The entire disclosure of each of such patent applications is hereby incorporated by reference into this specification.

### INCORPORATION BY REFERENCE OF CERTAIN PRIOR PATENTS

Applicant hereby incorporates by reference into this specification all of the disclosures in his prior patents U.S. Pat. No. 7,651,559 (issued Jan. 26, 2010) and U.S. Pat. No. 8,771,826 (issued Jul. 8, 2014).

### FIELD OF THE INVENTION

A mineral composition comprised of at least 90 weight percent of roofing granules, wherein said roofing granules comprise at least 40 weight percent of calcium carbonate, have a hardgrove grindability index of less than 70, contain less than 1.0 percent of particles smaller than 250 microns, contain less than 1.0 percent of particles greater than 2380 microns, contain from about 2 to about 10 percent of particles greater than 1,680 microns, contain less than 2 percent of particles less than 40 microns, and have a Hunter L value of from about 20 to about 30.

### BACKGROUND OF THE INVENTION

Roofing shingles are comprised of a headlap portion and a butt portion; granules are often used in both of such portions. Reference may be had, e.g., to U.S. Pat. No. 3,921,358 (a composite asphalt-impregnated felt roofing shingle comprising a rectangular sheet having a headlap portion and a butt portion), U.S. Pat. No. 4,717,614 (a shingle whose headlap portion is coated with a layer of asphaltic material), U.S. Pat. No. 4,900,589 (a process for applying granules to a moving sheet having a headlap area and a butt area for making a shingle roofing product), U.S. Pat. No. 6,358,305 (a process of preparing a darkened headlap for a roofing shingle), and the like. The entire disclosure of each of these United States patents is hereby incorporated by reference into this specification.

U.S. Pat. No. 6,358,305 of Ingo B. Joedicke discloses coated headlap granules that may comprise “ . . . limestone, rock, greenstone, nephylene syenite, gravel, slate, ganister, quartzite, and greystone . . . ” granules (see lines 30-34 of column 4). The patent discloses “The granules are typically in a size range between about 10 to 35 mesh, i.e. particle sizes which will pass through an 8 mesh screen but retained on a 35 mesh screen . . . ” (see lines 34-37 of column 4).

In the Examples of U.S. Pat. No. 6,358,305, an experiment is described in which “ . . . dedusted headlap-grade crushed rock aggregate . . . ” was used. However, Joedicke discloses that the aggregate may also be made from “ . . . limestone, . . . greenstone, nephylene syenite, gravel slate, ganister, quartzite, and greystone . . . ” (see lines 30 to 34 of column 4 of such patent); but he does not disclose, e.g., how one would prepare a “dedusted, headlap-grade” limestone material.

When a headlap material is made from limestone using the process disclosed in the Joedicke patent, the of the headlap granules so produced are not satisfactory.

It is an object of this invention to provide headlap granules with improved adhesion.

It is another object of this invention to provide headlap granules with improved abrasion resistance.

It is another object of this invention to provide headlap granules with substantially reduced porosity.

It is another object of this invention to provide headlap granules that are resistant to degradation by ultraviolet light.

It is another object of this invention to provide headlap granules with improved weatherability that retain their color properties after long exposure to sunlight.

It is yet another object of this invention to provide headlap granules that are resistant to attack by biological moieties, such as mildew and mold.

It is another object of this invention to provide headlap granules that, when heated in boiling water for 15 minutes, do not discolor the water.

These and other objects of the invention will be apparent upon reading the specification and referring to the drawings.

### SUMMARY OF THE INVENTION

In accordance with this invention, there is provided a mineral composition comprised of at least 90 weight percent of roofing granules, wherein said roofing granules comprise at least 40 weight percent of calcium carbonate, have a hardgrove grindability index of less than 70, contain less than 1.0 percent of particles smaller than 250 microns, contain less than 1.0 percent of particles greater than 2380 microns, contain from about 2 to about 10 percent of particles greater than 1,680 microns, contain less than 2 percent of particles less than 40 microns, and have a Hutner L value of from about 20 to about 30.

### BRIEF DESCRIPTION OF THE DRAWINGS

The invention will be described by reference to the following drawings, in which like numerals refer to like elements, and wherein:

FIG. 1 is a flow diagram of one preferred process of the invention;

FIG. 2 is a schematic of a test apparatus for determining the hydrophobicity of coated particles;

FIG. 3 is a flow diagram of a process for coating headlap granules with resin and pigment;

FIG. 4 is a schematic diagram of a preferred process of the invention; and

FIG. 5 is a schematic diagram of a shingle comprised of headlap particles.

### DESCRIPTION OF THE PREFERRED EMBODIMENTS

Roofing granules are well known to those skilled in the art. Reference may be had, e.g., to U.S. Pat. No. 3,884,706 (algicidal roofing granules), U.S. Pat. No. 4,092,441 (roofing granule treatment by coating with a metallic algicide), U.S. Pat. No. 4,359,505 (light colored roofing granules), U.S. Pat. No. 5,380,552 (method of improving adhesion between roofing granules and asphalt-based roofing materials), U.S. Pat. No. 6,156,289 (iron based roofing granules and method of coloring the same), U.S. Pat. No. 6,607,781 (roofing granules with a decorative metal appearance), U.S. Pat. No. 7,060,658 (roofing granules), and the like. The entire disclosure of each of these United States patents is hereby incorporated by reference into this specification.

Roofing granules made from coal slag have excellent adhesion properties. However, some have expressed concerns about the safety of coal slag (in general) and of roofing granules made from coal slag. It would be desirable to be able to make roofing granules with good adhesion properties from a more “environmentally friendly” material than coal slag.

Limestone is a substantially more “environmentally friendly” material than coal slag. Thus, e.g., limestone is often fed to chickens as a feed supplement. However, the adhesion properties of limestone granules are often not deemed to be adequate for use in roofing shingles.

### Adhesion Properties and Adhesion Testing of Roofing Granules

The adhesion properties of roofing granules is extensively discussed in U.S. Pat. No. 5,380,552 (“Method of improving adhesion between roofing granules and asphalt-based material”), the entire disclosure of which is hereby incorporated by reference into this specification.

At lines 37-48 of U.S. Pat. No. 5,380,552, it is disclosed that “The exterior, outer, or exposed surface of asphalt roofing systems and products is generally provided with a covering of granular material or roofing granules embedded within the coating asphalt. The granular material generally protects the underlying asphalt coating from damage due to exposure to light, in particular ultraviolet light. That is, the granules reflect light and protect the asphalt from deterioration by photodegradation. In addition, such granular material improves fire resistance and weathering characteristics. Further, colors or mixtures of colors of granular material may be selected for aesthetics.”

The adherence of the roofing granules to the roofing product is discussed at lines 56-63 of column 1 of U.S. Pat. No. 5,380,552, wherein it is disclosed that: “Good adherence of the roofing granules to the roofing product is beneficial. Loss of granules reduces the life of the roof, since it is associated with acceleration of photodegradation of the asphalt. In addition, the aesthetics of the roofing system may be compromised if granules are lost. Further, reduction of granule loss during installation improves safety conditions on the roof.”

Granule loss due to abrasion is discussed at the last paragraph of column 1 of U.S. Pat. No. 5,380,552, wherein it is disclosed that, “Granule loss can also occur due to physical abrasion of the granular surface. This may occur any time a person walks on an installed roof for maintenance, during installation of the roofing surface or by such environmental conditions as tree branches rubbing on the granular surface and the physical contact of rain or hail with the roofing surface.”

The benefits of reducing such granule loss are discussed at lines 34-37 of column 4 of U.S. Pat. No. 5,380,552, wherein it is disclosed that, “Improved granule retention increases the useful life of the roofing system by inhibiting exposure of the asphalt layer to ultraviolet light and thus inhibiting photodegradation of the coating asphalt.”

At lines 53 (of column 4) to 10 (of column 5), the substrate used in making roofing shingles is discussed. It is disclosed that, “A variety of materials may be utilized as the substrate for the roofing materials. In general, preferred materials comprise a non-woven matting of either fiberglass or cellulose fibers. Fiberglass matting is used most widely in the asphalt roofing products industry and is a typical and preferred substrate for use with methods and in products according to the present invention. Cellulose matting, sometimes referred to as organic matting or rag felt may also be utilized. Fiberglass matting is commercially available from Owens-Corning Fiberglass Corporation, Toledo, Ohio and Manville Roofing Systems, Denver, Colo. These commercially-available substrates are utilized in preferred embodiments of the present invention. It is recognized that any fiberglass mat with similar physical properties could be incorporated into the process of the present invention with satisfactory results. Generally, the fiberglass matting is manufactured from a silicate glass fiber blown in a non-woven pattern in streams of about 30-200 micrometers in diameter with the resultant mat approximately 1-5 millimeters in thickness. Cellulose felt (dry felt) is typically made from various combinations of rag, wood and other cellulose fibers or cellulose-containing fibers blended in appropriate proportions to provide the desirable strength, absorption capacity and flexibility.”

At lines 13-39 of column 5 of U.S. Pat. No. 5,380,552, the asphalt used in making roofing flux is disclosed. In this section of such patent, it is stated that: “Roofing asphalt, sometimes termed “asphalt flux”, is a petroleum based fluid comprising a mixture of bituminous materials. In the manufacture of roofing it is generally desirable to soak the absorbent felt or fiberglass mat until it is impregnated or saturated to the greatest possible extent with a ‘saturant’ asphalt, thus the asphalt should be appropriate for this purpose. Saturant asphalt is high in oily constituents which provide waterproofing and other preservatives. Substrates saturated with saturant asphalt are generally sealed on both sides by application of a hard or more viscous ‘coating asphalt’ which itself is protected by the covering of mineral granules. In the case of fiberglass mat based asphalt roofing products, it is well understood that the coating asphalt can be applied directly to the unsaturated fiberglass mat. The asphalts used for saturant asphalt and the coating asphalt are prepared by processing the asphalt flux in such a way as to modify the temperature at which it will soften. The softening point of saturant asphalt varies from about 37° C. to about 72° C., whereas the softening point of desirable coating asphalt runs as high as about 127° C. The softening temperature may be modified for application to roof systems in varying climates. In general, conventional, commercially available, asphalt systems may be utilized in applications of the present invention.”

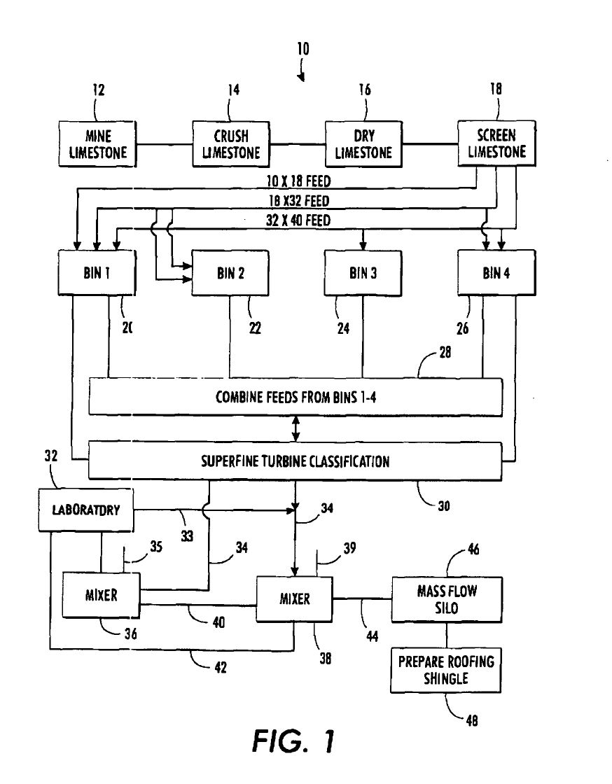

A conventional means of making roofing shingles is discussed at columns 7-9 of U.S. Pat. No. 5,380,552. In the paragraph beginning at line 46 of column 7 of such patent, it is disclosed that, “A schematic generally illustrating preparation of roofing shingles according to the present invention is illustrated in FIG. 1. Except for addition of adhesives as described, and modifications to accommodate addition of adhesives as described, the system in FIG. 1 is generally as presented in U.S. Pat. No. 4,352,837 . . . , incorporated herein by reference. In operation, a roll of dry felt or bonded fiberglass mat 12, (the substrate) in sheet form, is installed on a feed roll 13 and unwound onto a dry looper 14. The dry looper 14 acts as a reservoir of mat material that can be drawn upon during the manufacturing operation to inhibit stoppages which might otherwise occur when new or additional rolls are fed into the system. Dry felt, or mat 12, is subjected to a hot asphalt saturating process, indicated generally at 15, after it passes through dry looper 14. The purpose of the asphalt saturating process 15 is to eliminate moisture and to fill the intervening spaces of the fibers of the substrate 12 as completely as possible. The saturating process is conducted in a saturation tank 16 in which saturating asphalt is contained. Sufficient heat is added to maintain the saturant asphalt in saturation tank 16 as a flowable liquid, typically at application temperatures of at least about 70° C.”

In the paragraph beginning at line 3 of column 8 of U.S. Pat. No. 5,380,552, it is disclosed that: “Following saturation tank 16, the saturated web 17 is passed through wet looper 18 whereat it is cooled and shrunk, permitting excess asphalt material to be further drawn into the substrate. The mat 12, after saturation with saturating asphalt in tank 16, is next passed through looper 18 and is then directed into coating area 20, for uniform coating with a coating asphalt, to the top and bottom of the mat. Coating area 20 contains a material reservoir 22 and an applicator with a distributor nozzle 23, which are operated to apply the asphalt coating material to the top surface of the mat. Excess coating material flows over the sides of the substrate and into a pan (not shown) from which it is picked up by adjustable rollers 25 for application to the bottom of the web, in a uniform layer. If, the mat 12 comprises a fiberglass mat, it is well accepted in the industry that the coating asphalt can be directly applied to an unsaturated fiberglass mat, although it may be saturated first. Thus, the above-described process can be modified by feeding the fiberglass mat 12 directly from dry looper 14 to the coating area 20. At station 30, an adhesive reservoir 31 and applicator with distributor nozzle 32 are shown. The hot-melt adhesive is contained within adhesive reservoir 31 and is distributed to the upper surface of asphalt-coated web 33 by distributor nozzle 32. The adhesive may be applied in a variety of patterns and manners. In general, satisfactory results are obtained if the adhesive is applied in thin streams on the order of about 100-200 micrometers in diameter, for example with a blown-fiber adhesive spray gun such as that manufactured by PAM Fastening Technology, Model PAM 500KS. The thin streams may be applied in a random pattern or in other patterns. In general, for some improvement all that is required is that an effective amount of adhesive be applied to the asphalt-coated web 33 upper surface to which granular material is eventually applied. By the term ‘effective amount’, in this context, it is meant that an amount of adhesive is applied such that with respect to loss of granular material due to moisture attack or deterioration, the resulting product is improved. In addition, in many applications such an amount of adhesive will also improve dry adhesion. Hereinbelow, a ‘wet rub test’ and a ‘dry rub test’ are described, by which improvement can be evaluated. The dry rub test is conducted in accordance with ASTM Standard Test D 4977, and this standard test is also used in the present invention to determine the grams of granules lost.

In the paragraph beginning at line 49 of column 8 of U.S. Pat. No. 5,380,552, it is disclosed that: “Preferably the adhesive is distributed in thin streams of about 100-200 micrometers diameter until at least about 25% and more preferably 50-75% of the upper surface of asphalt-coated web 33 is covered thereby. Preferably, the adhesive is applied while the coating asphalt is still hot, i.e. on the order of at least 170° C. (340° F.). Still referring to FIG. 1, roofing granules are contained within hopper or blender 24. They are applied to the upper surface of adhesive-coated web 43 by gravity feed through granule distributor 42. Excess granules may be picked up by a mechanism generally indicated at spill area 46. In addition, the underside 44 of web 43 may be coated with talc, mica or other suitable materials which are applied by a distributor 48. In order to obtain proper adhesion of the granules, the sheet granules are subject to controlled pressure by compression rollers or drums 51 which force the granules into the asphaltic coating material (and adhesive) a predetermined depth. Cooling may be added to these drums or rollers to cool the hot asphalt as the granules are pressed or embedded therein.”

In the paragraph beginning at line 3 of column 9 of U.S. Pat. No. 5,380,552, it is disclosed that: “The web with granules embedded therein, 52, then travels through tension roller area 53 which assists in feeding the web material through the previously-disclosed process. The web material 52, with the granules embedded therein, is then fed to a finished or cooling looper 50. The primary function of this looper is to cool the sheet down to a point where it can be cut and packed without danger to the material. Subsequent to the cooling looper 50, the sheet may be fed to a roll roofing winder 54. Here the sheet is wound on a mandrel which measures the length of the material as it turns. When sufficient material has accumulated it is cut off, removed from the mandrel and passed on for wrapping. Alternatively, the sheet leaving the cooling looper 50 may be fed to a shingle cutter 56. It will be understood that the finished sheet or web may be cut to desired shapes or sizes and it may be modified, for example, by the addition of liners, application adhesives, or other modifications. The cut shapes or sizes are transferred to a stacking/packing area 58. The type of processing described above is well-known in the manufacturing of shingles or other roof materials, for example, as described in U.S. Pat. No. 4,352,837, which is incorporated herein by reference.”

A “Dry Rub Test” for determining the extent of adherence of the roofing granules is described at lines 12-46 of column 10 of U.S. Pat. No. 5,380,552. ASTM standard test D 4977-89 was used for the “Dry Rub Test” used in U.S. Pat. No. 5,380,837. ASTM test D 4977-03 is also used for the “Dry Rub Test” described in this specification.

As is disclosed at lines 12-46 of column 10 of U.S. Pat. No. 5,380,552, “The dry rub test is a standard test method for the determination of granular adhesion to mineral-surfaced roofing under conditions of abrasion. The procedure is described in ASTM standard D 4977-89, incorporated herein by reference. Dry rub tests conducted to evaluate granular adhesion in products according to the present invention, were conducted in compliance with this standard. In general, a brush with 22 holes, each containing bristles made of 0.012 inch diameter tempered steel wire (40 wires per hole, set with epoxy) was used to abrade the granular surface of a specimen of mineral-surfaced roofing. The adhesion is assessed by weighing the amounts of granules that are displaced and become loose as a result of the abrasion test. The testing apparatus is a machine designed to cycle a test brush back and forth (horizontally) across a specimen at a rate of 50 cycles in a period of about 60-70 seconds while the brush assembly rests on the specimen with a downward mass of 5 pounds±¼ ounce with a stroke link of 6±¼ inch. The testing machine used is available commercially, as the 3M Granule Embedding Test Machine and Abrasion Test Brushes, Minnesota Mining & Manufacturing, Inc., St. Paul, Minn. A minimum of two 2-inch by 9-inch specimens were utilized for each test, and any loose granules were removed from the specimen with gentle tapping. Each specimen was then weighed and the mass was recorded. The specimen was then clamped to the test machine and the brush was placed in contact with the specimen (with activation of the machine so that the specimen was abraded 50 complete cycles, the brush traveling parallel to the long axis of the specimen). The specimen was then removed and weighed; the loss in mass then being calculated.”

In one embodiment, it is preferred to determine the adhesion properties of the roofing granules by a procedure in which the granules are incorporated into a roofing shingle and the shingle is tested in accordance with ASTM 4977-03.

The test samples used to determine the adhesive characteristics of the coated granule particles are constructed using a petroleum based roofing asphalt which has been oxidized by blowing with air at a temperature of approximately 500° Fahrenheit, with a final Ring & Ball Softening Point of between 195° F. and 215° F. as determined by ASTM D 36, and a Needle Penetration of between 17 dmm and 23 dmm @ 77° F., as determined by ASTM D 5, this material being typically referred to in the trade as “Asphalt Shingle Coating.”

A commercially available bonded non-woven glass roofing fabric with a dry weight of approximately 92-95 grams/m³, consisting of sized individual “E” Glass filaments of 15.25-16.5 microns in diameter (“M” fiber) and from 0.75-1.25 inches in length, which are randomly oriented and bonded with a modified urea-formaldehyde resin binder, which has been applied to a level of 20% (dry weight), is coated on each side and saturated with a roofing asphalt compound consisting of Asphalt Shingle Coating containing at least 65% of a mineral filler such as limestone or stone dust, such compound typically referred to in the trade as “Filled Asphalt Coating.” The asphalt coated sheet is allowed to cool to room temperature.

The asphalt coated sheet is conditioned, preferably in an oven at 150 degrees Fahrenheit, for 30 minutes. After conditioning, samples of granule particles produced in the process depicted in FIG. 1 are applied to the top surface of the warm sheet by gravity feed, and the granule particles are roll pressed into the sheet. The finished sheet is allowed to cool to room temperature and is then cut into 2 inch by 9 inch sample specimens for further testing under ASTM D 4977-03. All loose granule particles are removed from the samples by gentle tapping of the specimen

At least two sample specimens are cut for each trial, with the long dimension of the specimen in the machine direction. Specimens are conditioned at room temperature of 23° C. plus or minus 2° C. (73.4° F. plus or minus 3.6° F.) for at least 30 minutes before testing. Granule abrasion tests are done using a Granule Test Apparatus as described in ASTM Procedure D 4977-03. All loose granules are removed from the specimens by gentle tapping of the sample. Each specimen is weighed to the nearest 0.01 grams and a record is made of the initial weight of the specimen. The specimen is centered in the sample holder of the Test Apparatus with the mineral surface facing up and the long axis of the specimen aligned with the brush stroke of the Test Apparatus. The Test Apparatus is activated such that the specimen is abraded 50 complete cycles, each cycle consisting of a forward stroke and a backstroke, with the brush travel remaining parallel to the long axis of the specimen. The specimen is removed from the sample holder and any loose granules are removed from the sheet by gently tapping the sample. The specimen is weighed to the nearest 0.01 grams and a record is made of the final weight of the specimen. The difference in weights for multiple samples of the same specimen are calculated and averaged to determine the average granule loss by abrasion.

### Preparation of Calcium Carbonate Containing Roofing Granules

In this portion of the specification, one preferred process for preparing a roofing granules will be described.

FIG. 1 is a flow diagram of a preferred process 10 for preparing some preferred limestone granules of this invention. In step 12 of this process, the limestone is mined by conventional means. The limestone so mined preferably contains at least about 40 weight percent of calcium carbonate. In one embodiment, the limestone so mined contains at least about 80 weight percent of calcium carbonate and, more preferably, at least about 90 weight percent of calcium carbonate.

The term “limestone,” as used in this specification, has the meaning set forth at pages 475-476 of George S. Brady et al.'s “Materials Handbook,” Thirteenth Edition“(McGraw-Hill, Inc., New York, N.Y., 1991. As is disclosed at such page 475, limestone is “a general name for a great variety of calcite rocks . . . . In a broad sense limestone includes dolomite, marble, chalk, or any mineral consisting largely of CaCO₃. When the proportion reaches 45% and the limestone is the double carbonate CaCO₃.MgCO₃, it is called dolomite.”

Limestone, processes for mining it, processes for treating it, methods of using it, and compositions containing it are well known to those skilled in the art. Reference may be had, e.g., to U.S. Pat. No. 3,601,376 (process for preheating limestone), U.S. Pat. No. 3,617,560 (limestone neutralization of dilute acid waste waters), U.S. Pat. No. 3,722,867 (method of calcining limestone), U.S. Pat. No. 3,900,434 (wallboard tape joint composition comprised of limestone), U.S. Pat. No. 4,015,973 (limestone-expanding clay granules), U.S. Pat. No. 4,026,7632 (use of ground limestone as a filler in paper), U.S. Pat. No. 4,231,884 (water retardant insulation composition comprising treated low density granular material and finely divided limestone), U.S. Pat. No. 4,237,025 (product comprising lime or limestone and Graham's salt), U.S. Pat. No. 4,239,736 (method for increasing the brightness of limestone), U.S. Pat. No. 4,272,498 (process for comminuting and activating limestone by reaction with carbon dioxide), U.S. Pat. No. 4,316,813 (limestone-based sorbent agglomerates), U.S. Pat. No. 4,390,349 (method for producing fuel gas from limestone), U.S. Pat. No. 4,430,281 (process for palletizing limestone fines), U.S. Pat. No. 4,594,236 (method of manufacturing calcium carbide from limestone), U.S. Pat. No. 4,614,755 (protective coating composition comprising a blend of polyvinyl acetate, hydraulic cement, EVA, and limestone), U.S. Pat. No. 4,629,130 (process for preparing finely divided limestone), U.S. Pat. No. 4,671,208 (clay and limestone composition), U.S. Pat. No. 4,710,226 (fluidization of limestone slurries), U.S. Pat. No. 4,781,759 (limestone and clay traction aid) U.S. Pat. No. 4,824,653 (method of bleaching limestone), U.S. Pat. No. 5,228,895 (fertilizer and limestone product), U.S. Pat. No. 5,375,779 (process for grinding limestone to a predetermined particle size distribution), U.S. Pat. No. 5,908,502 (limestone filled Portland cements), and the like. The entire disclosure of each of these United States patents is hereby incorporated by reference into this specification.

Referring to FIG. 1, and in step 12 thereof, limestone is mined. One may, e.g., use many of the conventional techniques used for mining minerals. Reference may be had, e.g., to U.S. Pat. No. 3,737,704 (control blasting), U.S. Pat. No. 3,775,984 (mining method and method of land reclamation), U.S. Pat. No. 3,849,927 (mining method using control blasting), U.S. Pat. No. 4,189,184 (rotary drilling and extraction process), U.S. Pat. No. 4,198,097 (method of mining), U.S. Pat. No. 4,116,488 (in-situ mining method and apparatus), U.S. Pat. No. 4,134,619 (subterranean mining), U.S. Pat. No. 4,323,281 (method for surface mining), U.S. Pat. No. 4,425,057 (method of mining) U.S. Pat. No. 4,699,429 (mining machine system), U.S. Pat. No. 5,667,729 (apparatus and method for continuous mining), U.S. Pat. No. 5,709,433 (apparatus for continuous mining), U.S. Pat. No. 5,782,539 (wall-to-wall surface mining process), U.S. Pat. No. 5,810,427 (apparatus and method for continuous mining), and the like. The entire disclosure of each of these United States patents is hereby incorporated by reference into this specification.

In one embodiment, the limestone is mined in substantial accordance with the procedure described at columns 9 through 11 of U.S. Pat. No. 7,651,559, the entire disclosure of which is hereby incorporated by reference into this specification.

In one embodiment, it is preferred that the limestone so mined contain at least about 40 weight percent of calcium carbonate and, more preferably, about 60 weight percent of calcium carbonate. In one preferred embodiment, the limestone so mined contains at least about 70 (and more preferably at least about 80) weight percent of calcium carbonate. In another embodiment, the limestone contains at least about 85 weight percent of calcium carbonate. In another preferred embodiment, the limestone so mined contains at least about 90 weight percent of calcium carbonate and, more preferably, at least about 95 weight percent of calcium carbonate.

In one preferred embodiment, the limestone so mined is biodegradable. As used in this specification, the term biodegradable refers to a substance that can be decomposed by the biochemical systems of biological organisms (refer to the means, e.g., by which chickens decompose limestone fed to them). Reference may be had, e.g., to U.S. Pat. No. 3,919,163 (biodegradable containers), U.S. Pat. No. 4,356,572 (biodegradable implant used as bone prosthesis), U.S. Pat. No. 5,174,581 (biodegradable clay pigeon), U.S. Pat. No. 5,316,313 (frangible biodegradable clay target), U.S. Pat. No. 5,651,550 (biodegradable edible target), U.S. Pat. No. 5,993,530 (biodegradable resin composition), U.S. Pat. No. 6,029,395 (biodegradable mulch mat), U.S. Pat. No. 6,573,340 (biodegradable polymer films), U.S. Pat. No. 6,890,872 (fibers comprising starch and biodegradable polymers), and the like. The entire disclosure of each of these United States patents is hereby incorporated by reference into this specification.

In one preferred embodiment, the limestone so mined contains less than 10 milligrams per kilogram of arsenic, less than 150 milligrams per kilogram of barium, less than 2 milligram per kilogram of cadmium, less than 10 milligrams per kilogram of chromium, less than 10 milligrams per kilogram of lead, less than 0.4 milligrams per kilogram of mercury, less than 2.0 milligram per kilogram of selenium, and less than 0.4 milligrams per kilogram of mercury. As will be apparent, 1 milligram per kilogram is equivalent to 1 part per million.

In one preferred embodiment, the limestone so mined contains less than about 100 parts per million of a leachable metal selected from the group consisting arsenic, barium, cadmium, chromium, lead, mercury, selenium, silver, and mixtures thereof. The presence, or absence, of such a leachable metal may be determined, e.g., in accordance with the “Toxicity Characteristic Leaching Procedure” (“TCLP”) that is set forth in the Environmental Protection Agency (EPA) method SW 846-1311. This “TCLP” test is well known to those skilled in the art and is described in, e.g., U.S. Pat. No. 5,127,963 (process for detoxifying lead contaminated materials), U.S. Pat. No. 5,193,936 (fixation and stabilization of lead in contaminated soil and solid waste), U.S. Pat. No. 5,196,620 (fixation and utilization of ash residue from the incineration of municipal solid waste), U.S. Pat. No. 5,245,114 (immobilization of lead in bottom ash), U.S. Pat. No. 5,252,003 (attenuation of arsenic leaching from particulate material), U.S. Pat. No. 5,278,982 (fixation and stabilization of metals in contaminated materials), U.S. Pat. No. 5,397,478 (fixation and stabilization of chromium in contaminated materials), U.S. Pat. No. 5,421,906 (methods for removal of contaminants from surfaces), U.S. Pat. No. 5,430,223 (immobilization of lead in solid residues from reclaiming metals), U.S. Pat. No. 5,430,234 (process for removing phosphorous and heavy metals from phosphorous trichloride still bottoms residue), U.S. Pat. No. 5,678,235 (safe ceramic encapsulation of hazardous waste with specific shale material), U.S. Pat. No. 5,859,306 (method of treating arsenic-contaminated matter using aluminum compounds), U.S. Pat. No. 5,806,908 (water insoluble heavy metal stabilization process), U.S. Pat. No. 5,877,393 (treatment process for contaminated waste), U.S. Pat. No. 5,897,685 (recycling of CdTe photovoltaic waste), U.S. Pat. No. 5,898,093 (treatment process for contaminated waste), U.S. Pat. No. 6,717,363 (control of leachable mercury in fluorescent lamps by gelatin), U.S. Pat. No. 6,383,398 (composition and process for remediation of waste streams), U.S. Pat. No. 6,590,133 (reducing lead bioavailability), U.S. Pat. No. 6,637,354 (coal combustion products recovery process), U.S. Pat. No. 6,688,811 (stabilization method for lead projectile impact area), U.S. Pat. No. 6,781,302 (low pressure mercy vapor fluorescent lamps), and the like. The entire disclosure of each of these United States patents is hereby incorporated by reference into this specification.

By way of illustration, the TCLP test is discussed in U.S. Pat. No. 5,860,908, the entire disclosure of which is hereby incorporated by reference into this specification. This patent discloses that “The leaching of heavy metal bearing wastes and human and biological exposure to heavy metal content has long been of concern to environmental regulators and waste producers. Under the Resource Conservation and Recovery Act (RCRA), solid waste is classified by the U.S. Environmental Protection Agency (EPA) as hazardous waste if excessive amounts of heavy metals leach from the waste when tested under the Toxicity Characteristic Leaching Procedure (TCLP). EPA also regulates the land disposal of certain heavy metal bearing wastes depending on the content of the heavy metals regardless of the leaching potential. In addition, several state governments require solid wastes with elevated levels of heavy metals be disposed of as a hazardous waste. Disposal of waste at a hazardous waste landfill is typically more expensive than disposal at non-hazardous waste landfills.”

Referring again to FIG. 1, it should be noted that not only does the limestone so mined preferably contain less than 100 parts per million of a leachable metal selected from the group consisting arsenic, barium, cadmium, chromium, lead, mercury, selenium, silver, and mixtures thereof, but it also preferably contains less than 100 parts per million of a metal selected from the group consisting arsenic, barium, cadmium, chromium, lead, mercury, selenium, silver, and mixtures thereof, regardless of whether such metal is “leachable” in accordance with the TCLP test.

There has been some concern expressed that roofing granules made from slag might contain carbon-containing residues that might be mutagenic and/or carcinogenic when incorporated into living biological organisms. Thus, e.g., the “oxidation products” from cigarette smoke have been reported to contain many different mutagen and/or carcinogens. Similarly, the “oxidation products” produced by cooking a steak over a very high flame also contain many mutagens and/or carcinogens.

It appears that many roofing granules are prepared by combusting coal. Thus, e.g., U.S. Pat. No. 6,258,456, the entire disclosure of which is hereby incorporated by reference into this specification, discusses the preparation of roofing granules from slag produced from the combustion of coal, disclosing that, “Each year many tons of materials such as slag and fly ash resulting from combustion of coal in boilers, hereinafter referred to as coal slag and coal fly ash, found in electric generating plants are produced. In the United States in 1993, for example, over 5.6 million metric tons of coal slag and 43.7 million metric tons of coal fly ash were produced as coal combustion byproducts. The greatest use of such materials is found in roofing granules and as sandblasting materials. Other uses are found in cement and concrete products, snow and ice control, and grouting materials. However, only about 55% of the coal slag and only about 22% of the coal fly ash is incorporated into useful products. The remaining amount is generally disposed of in landfills.”

Referring again to FIG. 1, and in one preferred embodiment, both the limestone mined (see FIG. 1) and the coated granular material made therefrom (see FIG. 1) preferably contain less than 100 parts per million of a metal selected from the group consisting arsenic, barium, cadmium, chromium, lead, mercury, selenium, silver, and mixtures thereof.

In one preferred embodiment, the mined limestone used in the roofing granules of this invention has a hardgrove grindability index (HGI) of less than about 70 and, more preferably, less than about 68. In another preferred embodiment, the hardgrove grindabilty index of the limestone is less than 60 and, more preferably, from about 55 to about 58.

The hardgrove grindability index is well known to those skilled in the art and is described, e.g., in the specification and the claims of U.S. Pat. No. 4,419,456 (method for the disposal of shot coke), U.S. Pat. No. 4,521,278 (method for producing needle coke), U.S. Pat. Nos. 5,007,987, 5,389,353, 5,882,377, 6,882,517, and the like. The entire disclosure of each of these United States patents is hereby incorporated by reference into this specification.

The test for determining the hardgrove grindability index is described in A.S.T.M. Standard Test D409-85 “Standard Test Method for Grindability of Coal by the Hardgrove-Machine Method.” This A.S.T.M. test is also described, e.g., in U.S. Pat. No. 4,420,445 (coal pellets production), U.S. Pat. Nos. 4,419,456, 6,083,289, 6,692,544, and the like. The entire disclosure of each of these United States patents is hereby incorporated by reference into this specification.

In one embodiment, the limestone used contains less than about 4 weight percent of magnesium and, more preferably, less than about 2 weight percent of magnesium.

In one preferred embodiment, the limestone mined contains less than 2 weight percent of acid insoluble products, such as silica, aluminum oxides, iron oxides. In one aspect of this embodiment, the limestone mined contains less than 1.5 weight percent of acid insoluble product(s). It is preferred that the limestone contain less than about 1 weight percent of silica and less than 0.5 weight percent of aluminum oxide material and/or iron oxide material.

In one embodiment, the ore used in the process of this invention is dolomite, and it may replace some or all of the limestone used in the process.

Dolomite is a carbonate of calcium and magnesium that may be represented by the formula CaMg(CO₃)₂. This carbonate mineral has a hexagonal symmetry and a structure similar to that of calcite, but with alternate layers of calcium ions being completely replaced by magnesium. See, e.g., page 568 of Sybil P. Parker's “McGraw-Hill Dictionary of Scientific and Technical Terms,” Fourth Edition (McGraw-Hill Book Company, New York, N.Y., 1989).

In one preferred embodiment, dolomitic limestone is used in the process 10.

Referring again to FIG. 1 and in step 14 thereof, the limestone from step 12 that preferably has the required degree of hardgrove grindability is subjected to crushing in step 14 and screening in step 18. The crushing step is discussed at lines 15 through 64 of column 12 of U.S. Pat. No. 7,651,559; the screening step is disclosed at columns 12 through 14 of such United States patent. The entire disclosure of such patent is hereby incorporated by reference into this specification.

In one preferred embodiment, limestone material from a “chat pile” is used which ranges in size from 0.5 inches to 74 microns; at least 90 weight percent of the limestone particles in such material is within such range.

In this embodiment, the limestone material is dried to a moisture content of less than about 1.0 percent (and preferably less than 0.2 percent) by subjecting it to a temperature of from about 250 to about 300 degrees Fahrenheit. Thereafter the dried material is classified to screening (by, e.g., the multideck vibrational screening process described elsewhere in this specification). A 10 mesh×40 mesh material produced by the screening process is then treated in an air separator to remove −200 mesh material (material which is smaller than 74 microns). The air separated material is then coated with one of the coating processes described elsewhere in this specification.

Referring again to FIG. 1, and in one preferred embodiment, a series of four or more crushers, such as rotary impact crushers, are used to crush the limestone to ⅛″, i.e. substantially all of the crushed particles are smaller than ⅛″. These crushers are well known and are described, e.g., in U.S. Pat. No. 3,608,841 (rotary impact crusher), U.S. Pat. No. 3,737,678 (rotary impact crusher having a continuous rotary circumference), U.S. Pat. No. 4,844,364 (rotary impact crusher), U.S. Pat. No. 4,844,365 (rotary impact crusher), U.S. Pat. No. 4,877,192 (rotary impact crusher main wear tip), U.S. Pat. No. 4,923,131 (rotary impact crusher rotor), and the like. The entire disclosure of each of these United States patents is hereby incorporated by reference into this specification.

In this embodiment, and in the first crushing step, the size of the limestone is preferably reduced to minus 6 inches, that is, the top maximum size is less than about 6 inches. The first crushed material may then be crushed in a second crusher to reduce its size to about minus 1.5″. The second crushed material may then be crushed in a third crusher to reduce its size to about minus 0.375″. The third crushed material may then be crushed in a fourth crusher to reduce its size to about minus ⅛″

In another embodiment, the material from the first crusher is preferably feed to a screener, which separates the material so fed into various size fractions. One may use any of the screeners known to those skilled in the art. Thus, one must use a vibratory screener such as, e.g., a screener utilizing mechanical vibration with inclined screen surfaces, a screener using mechanical vibration with horizontal screen surfaces, an electromagnetic vibratory screener, and the like.

By way of further illustration, one may use one or more of the screening devices disclosed at pages 21-39 to 21-45 of Robert H. Perry et al.'s “Chemical Engineer's Handbook,” Fifth Edition (McGraw-Hill Book Company, New York, N.Y., 1973. Thus, e.g., one may use Grizzly screens (see pages 21-40 to 21-41), revolving screens (see page 21-41), mechanical shaking screens (see page 21-41), vibrating screens (see page 21-41), mechanically vibrated screens (see page 21-41), electrically vibrated screens (see page 21-41), oscillating screens (see page 21-42), reciprocating screens (see page 21-42), gyratory screens (see page 21-42), gyratory riddles (see page 21-42), and the like.

In this embodiment, any material from the screener with particles sized greater than about 1.75 inches is preferably fed via line a second crusher, wherein it is crushed to sizes smaller than 1.75 inches. Material from the second crusher is then fed to a third crusher that reduces the size of the limestone particles to a top size of 0.625 inches.

Many other means of producing crushed minus ⅛″ ore may be used in the process 10. Thus, e.g., one may use a series of many impact crushing assemblies which, by means of a multiplicity of crushers and/or classifiers, produce many differently sized products.

Referring again to FIG. 1, and in a preferred embodiment, the ⅛″ crushed ore from step 14 is then fed to drying step 16 in which it is dried to a moisture content of less than about 1 weight percent and, preferably, to less than about 0.2 weight percent. It is preferred to use a rotary dryer to effectuate such drying. These dryers are described, e.g., on pages 20-32 to 20-44 Perry and Chilton's “Chemical Engineers' Handbook,” Fifth Edition (McGraw-Hill Book Company, New York, N.Y., 1973). It is preferred to use a temperature of at least about 220 degrees Fahrenheit in the rotary dryer in order to vaporize all of the water in the ore so that it is “bone dry” (i.e., it contains less than about 0.1 weight percent of water).

The dried material from step 16 is then screened in step 18. In is preferred to utilize a multiplicity of multiple deck screeners, such as, e.g., four multiple deck screeners, in such step 18.

Multiple deck screeners are well known to those skilled in the art; reference may be had to U.S. Pat. No. 5,341,939, the entire disclosure of which is hereby incorporated by reference into this specification. This patent claims (in claim 1 thereof) “1. A vibrating screen apparatus for material screening including in combination: a frame; at least first and second elongated vibrating screen decks having first and second sides and first and second ends; first and second pivot means for pivotally mounting the first ends of said first and second vibrating screen decks, respectively, on said frame, with said first vibrating screen deck located above said second vibrating screen deck; first and second means coupled with first and second said vibrating screen decks, respectively, for rotating said first and second vibrating screen decks about said first and second pivot means for varying the angle of said first and second vibrating screen decks relative to said frame; means for vibrating said first and second vibrating screen decks; and flexible curtain members extending between the first sides and the second sides, respectively, of said first and second vibrating screen decks to ensure that material falling through said first vibrating screen deck drops onto said second vibrating screen deck.”

U.S. Pat. No. 5,341,939, in column 1 thereof, discusses other multiple deck screeners. It is disclosed in such column 1 that, “Vibrating material sorting screens are used in a variety of applications, including sand and gravel businesses and in mining operations. Such vibrating screens are used to sort material size, and typically comprise an elongated deck, which slopes downwardly from the feed end to the material delivery end. Usually, the decks are mounted in a deck holding frame, which, in turn, is supported on springs extending to a platform on a support surface. An eccentric vibrator is employed to vibrate the frame on the springs to cause a shaking of the material poured onto the vibrating screen deck to facilitate the movement of the material down the deck, and to expedite the material separation. Both the aperture of the screen and the size of the deck determines the separation size of the materials, and any material which is larger than the screen aperture finally is supplied from the end of the deck to a suitable receptacle. All material which is smaller than the screen aperture falls through the deck for further separation or processing.”

U.S. Pat. No. 5,431,939 also discloses (in such column 1) that: “In some mining applications, the vibrating screen apparatus has two decks located one above the other, with the larger screen aperture on the top deck and a smaller screen aperture on the lower deck. In the sand and gravel business, three to five decks frequently are used, with the decks progressing in screen aperture from the largest at the top to the smallest at the bottom. Usually, all of these decks are mounted together in a single frame, vibrated by a single vibrating apparatus. The slope of each deck, from the feed end or material receiving end to the delivery end, is fixed once the vibrating screen apparatus is assembled. In addition, a single vibrating weight and drive motor is used; so that the magnitude and frequency of vibration of the entire unit is the same.”

U.S. Pat. No. 5,431,939 also discloses (in such column 1) that, “When a multiple deck vibrating screen unit is employed, the magnitude and frequency of the vibration necessarily is a compromise between the optimum magnitude and speed of vibration required for the deck separating the larger size materials and the magnitude and speed of vibration required for the deck which is separating the smaller sized materials. In addition, the rate at which materials traverse the deck from the feed end to the delivery end varies, depending upon the size of the material; so that a compromise generally is made in the slope of the decks during the manufacturing of a multiple deck unit. In some cases, the slope angle of the different decks can be made to vary relative to one another; but once the unit is made, the different slope angles cannot further be adjusted in a typical deck.”

U.S. Pat. No. 5,341,939 also discloses that, “When multiple deck units having three or more decks are employed, the compromises, which must be reached between the slope or angle of the different decks and the magnitude and speed of the vibrator, result in ever greater departures from the optimum, which would be desired for each deck having a single screen size. In view of this, it is desirable to provide a vibrating screen apparatus for a multiple deck unit which may be operated with each deck vibrated independently of the others, and where the angle or slopes of the decks may be independently varied, as desired.”

One preferred multideck screener is the “Multi-Vib Screener” sold by Midwestern Industries, Inc. of Massillon, Ohio. This screener is described on the website for Midwestern Industries as follows: “Until recently, vibrating screens were calculated by using only two dimensions—width determined capacity and length determined efficiency. Midwestern Industries' Multi-Vib screens utilize a third dimension—‘depth’— in addition to width and length to calculate size.”

It is also disclosed on such website that, “The ‘depth’ dimension is accomplished by using five screening decks arranged one above the other to impart rapid vertical movement to the material being screened. The material passes through the top coarse screen to the progressively smaller screen openings below where it is retained—or passes through the finest screen on the fifth deck . . . . Multi-Vib units are available in three models . . . . They are powered by belt-free vibrating motors . . . . ”

In the embodiment depicted in FIG. 1, a series of at least four multiple deck screeners (not shown) each will have an 8 mesh screen (2.38 millimeter sieve openings), a 10 mesh screen (1.68 millimeter openings), an 18 mesh screen, a 32 mesh screen (500 micron openings), and a 40 mesh screen. These screeners thus produce, e.g., a 10×18 feed (i.e., a feed that passes through the 10 mesh screen but is retained on the 18 mesh screen), an 18×32 feed (i.e., a feed that passes through the 18 mesh screen but is retained on the 32 mesh screen), a 32×40 feed, etc.

The 8×10 output from the multiple deck screeners can either be utilized as a non-headlap product and/or recycled in whole or in part. When it is to be recycled, it may be crushed again in one of the crushers (such as, e.g., the fourth crusher) and then fed again to one or more of the multiple deck screeners.

The other outputs from the different multiple deck screeners may be fed to bin 20 (“bin 1”), bin 22 (“bin 2”), bin 24 (“bin 3”), and/or bin 24 (“bin 4”), and the output from one or more of these bins may then be combined in step 28 and/or subject to “superfine air classification” in step 30 in order to produce the desired particle size distribution.

In the embodiment depicted in FIG. 1, different feeds from the multideck screeners and/or different combinations of feeds and/or different amounts of the feeds are fed to each of the bins 20, 22, 24, and 26 so that, when the material in these bins is combined and/or further purified (in turbine classification step 30), the desired particle size distribution will be obtained. As will be apparent, there are a substantial number of combinations of conditions that will produce the desired particle size distribution. For any particular feed stock (such as, e.g., the 18/32 feedstock), one may feed some, all, or none of such feed stock to bin 20 and/or bin 22 and/or bin 24 and/or bin 26. One may, e.g., feed material from bin 20 and/or bin 22 and/or bin 24 and/or bin 26 to the turbine classification step 30 prior to the time such material is combined in step 28.

In one embodiment, the particle size of the material used in the process varies from 10 mesh (2000 microns) to 35 mesh (500 microns).

In another embodiment, at least about 90 weight percent of the particles have a maximum dimension within the range of from about 420 to about 2000 microns.

In another embodiment, the material has a particle size distribution such that from about 2 to about 10 weight percent of the particles are retained on a 12 mesh (1680 micron) screen and/or from about 23 to about 50 weight percent of the particles are retained on a 16 mesh (1190 micron) screen, and/or from about 48 to about 77 weight percent of the particles are retained on a 20 mesh (840 micron) screen, and/or from about 80 to about 95 weight percent of the particles are retained on a 30 mesh (590 micron) screen, and/or from about 98 to about 99.5 weight percent of the particles are retained on a 40 mesh (420 micron) screen.

In one embodiment, less than 2 weight percent of the particles are smaller than 420 microns (40 mesh), and less than 10 weight percent of the particles are larger than 1700 microns.

In one embodiment, not shown, a controller (not shown) is operatively connected to laboratory 32 and, additionally, bin 20, bin 22, bin 24, bin 26, mixer 38, and classifier 30. By analyzing and monitoring the material present in each of these locations, the controller can modify the feeds from the multideck screeners and/or from the bins 20, 22, 24, and 26 and/or from the turbine classifier 30 to insure that the material discharged via line 34 from the turbine classifier has the desired particle size distribution.

Referring again to FIG. 1, in one embodiment, each of the multideck screeners (not shown) comprises a 4 mesh screen, an 11 mesh screen, and 18 mesh screen, a 24 mesh screen, and a 32 Mesh screen.

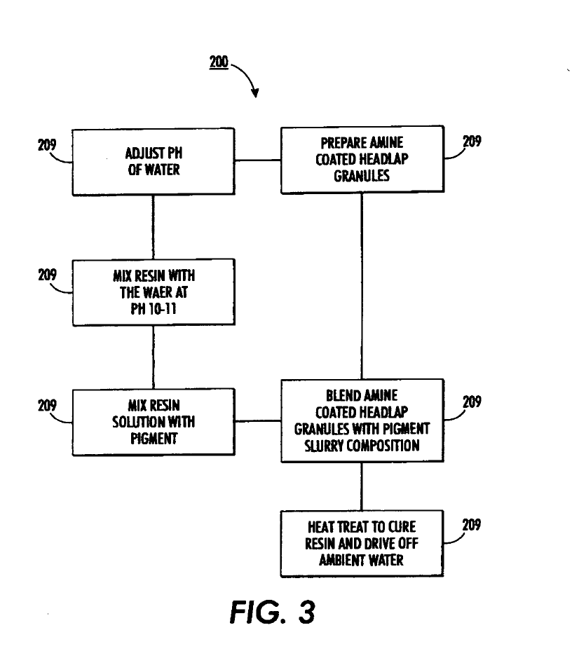

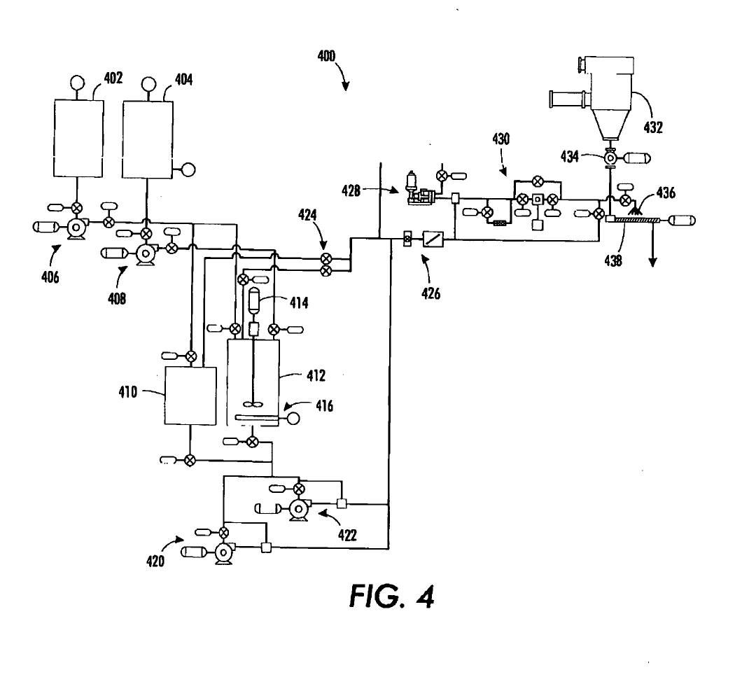

In one embodiment, the material retained on the 18 mesh screen may be coated with pigment and/or adhesion promoting agent (as is described elsewhere in this specification) and used to prepare headlap particles. The pigment coating process is described in FIG. 3; and the adhesion promoting agent process is described in FIG. 4.

In one embodiment, some or all of the material retained on the 32 mesh screen may be “classified” in the superfine turbine classification step 30 described elsewhere in this specification to produce a coarse fraction that may be used in headlap production and a fine fraction that may either be discarded or used to produce other products.

Referring again to FIG. 1, some or all of the material fed to bins 20, 22, 24, and 26, either before or after they are combined in step 28, may be fed to a superfine turbine classifier in step 30. In such step 30, the feed(s) are subjected to air flow classification in order to reduce the concentration of fines” in such feed(s). Thus, e.g., the concentration of particles smaller than 250 microns may be reduced in such step 30.

Airflow separators are well known to those skilled in the art, and they are referred to in the claims of U.S. Pat. No. 5,541,831 (computer controlled separator device), U.S. Pat. No. 5,943,231 (computer controlled separator device), U.S. Pat. No. 6,351,676 (computer controlled separator device), and the like. The entire disclosure of each of these United States patents is hereby incorporated by reference into this specification.

Air flow separators are also discussed in U.S. Pat. No. 3,772,857 (water air separator), U.S. Pat. No. 3,874,444 (duo-baffle air separator apparatus), U.S. Pat. No. 3,877,454 (air separator), U.S. Pat. No. 3,962,072 (air separator apparatus), U.S. Pat. No. 4,662,915 (powder air separator), U.S. Pat. No. 4,824,559 (rotary air separator), U.S. Pat. No. 5,244,481 (vertical air separator), U.S. Pat. No. 5,788,727 (centrifugal air separator), U.S. Pat. No. 6,053,967 (air separator), U.S. Pat. No. 6,664,479 (method and air separator for classifying charging material reduced in size), and the like.

In one preferred embodiment, the air flow separator is a 72 inch “SuperFine Air Classifier” manufactured by Sturtevant, Inc. of 348 Circuit Street, Hanover, Ma.

Referring again to FIG. 1, and to the preferred embodiment depicted therein, the material fed from the air flow separation step 30 via line 34 preferably ranges in particle size from about 100 to about 2,500 microns, with at least 60 weight percent of the particles having sizes in the range of from about 600 to about 1400 microns. In one embodiment, at least about 70 weight percent of the particles have sizes in the range of from about 600 to about 1400 microns. In another embodiment, at least about 80 weight percent of the particles have sizes in the range from about 600 to about 1400 microns. In yet another embodiment, at least about 85 weight percent of the particles have sizes in the range of from about 600 to about 1400 microns.

In one embodiment, the material fed from airflow separator 34 (via line 38) ranges in particle size from about 500 to about 2500 microns (and, more preferably, from about 500 to about 2,000 microns). The airflow separator 30 preferably reduces the “fines content” of the particle compact so that the output in line 34 contains less than about 4 weight percent of particles smaller than 250 microns (60 mesh) and, more preferably, less than about 3 weight percent of particles smaller than 250 microns. In one embodiment, the material fed via line 34 contains less than 2 weight percent of material smaller than 250 microns and, more preferably, less than about 1 weight percent of material smaller than about 250 microns. In one embodiment, the material fed via line 34 contains less than about 0.4 weight percent of material smaller than 250 microns.

In one embodiment, the material fed from airflow separator 30 contains at least 95 weight percent of particles smaller than 3,350 microns.

In one embodiment, the material fed from air flow separator 30 contains at least 95 weight percent of particles smaller than 2,360 microns.

In one embodiment, the material fed from airflow separator 30 contains at least 95 weight percent of particles smaller than 1,700 microns.

In one embodiment, the material fed from airflow separator 30 contains at least 60 weight percent of particles smaller than 1,000 microns.

In one embodiment, the material fed from airflow separator 30 contains at least 30 weight percent of particles smaller than 850 microns.

In one embodiment, the material fed from airflow separator 30 contains at least 3 weight percent of particles smaller than 600 microns.

In one embodiment, the material fed from airflow separator 30 contains at least 97 weight percent of particles greater than 425 microns.

In one embodiment, the material fed from airflow separator 30 contains at least 98 weight percent of particles greater than 300 microns.

In one embodiment, the material fed from airflow separator 30 contains at least 98 weight percent of particles greater than 250 microns.

In one embodiment, the material fed from airflow separator 30 contains at least 99 weight percent of particles greater than 212 microns.

In one embodiment, the material fed from airflow separator 30 contains at least 99.5 weight percent of particles greater than 180 microns.

In one embodiment, the material fed from airflow separator 30 (via line 34) contains at least 97 weight percent of material greater than 30 mesh (with an average of 97.4 weight percent material greater than 30 mesh), at least 99 weight percent of material greater than 40 mesh (with an average of 99.07 weight percent greater than 40 mesh), at least 99 weight percent of material greater than 60 mesh (with an average of 99.55 weight percent greater than 60 mesh), and at least 99 weight percent of material greater than 100 mesh (with an average of 99.73 weight percent greater than 100 mesh). In one aspect of this embodiment, the material fed via line 34 contains from about 2 to about 6.5 weight percent of material greater than 12 mesh (with an average of 4.15 weight percent greater than 12 mesh), from about 35 to about 63 weight percent of material greater than 16 mesh (with an average of 45.77 weight percent greater than 16 mesh), and from 69 to 94 weight percent greater than 20 mesh (with an average of 78.95 weight percent greater than 20 mesh).

In the process depicted in FIG. 1, at least four gradations of limestone particles are combined to make the limestone headlap material.

In another embodiment, the material fed from classifier 30, via line 24, contains from about 98.0 to 99.9 weight percent of particles smaller than 10 mesh (1700 microns), from about 93.5 to about 97.5 weight percent of particles smaller than 12 mesh (1400 microns), from about 38 to about 60 weight percent of particles smaller than 1000 microns, from about 5 to about 20 weight percent of particles smaller than 850 microns, from about 0.5 to about 6 weight percent of particles smaller than 600 microns, from about 0.1 to about 1.8 weight percent of particles smaller than 425 microns (40 mesh), and from about 0.04 to about 1.2 weight percent of particles smaller than 250 microns.

Referring again to FIG. 1, and to the preferred embodiment depicted therein, a portion of the material produced in airflow separator may be periodically withdrawn via line 33 to laboratory 32, in order to test the particle size distribution of such material; similarly, material may be withdrawn from mixer 28 to lab 32. The particle size analysis may be conducted by conventional means. Reference may be had, e.g., to pages 92-109 of Barry A. Wills “Mineral Processing Technology,” Sixth Edition (Butterworth Heinemann, Oxford, 1997. Reference also may be had, e.g., to U.S. Pat. No. 4,288,162 (measuring particle size distribution), U.S. Pat. No. 4,736,311 (particle size distribution measuring apparatus), U.S. Pat. No. 4,742,718 (apparatus for measuring particle-size distribution), U.S. Pat. No. 5,094,532 (method and apparatus for measuring small particle size distribution), U.S. Pat. No. 5,164,787 (apparatus for measuring particle size distribution), U.S. Pat. No. 5,185,641 (apparatus for simultaneously measuring large and small particle size distribution), U.S. Pat. No. 5,578,771 (method for measuring particle size distribution), U.S. Pat. No. 5,682,235 (dry particle-size distribution measuring apparatus), U.S. Pat. No. 6,191,853 (apparatus for measuring particle size distribution and method for analyzing particle size distribution), U.S. Pat. No. 6,252,658 (particle size distribution measuring apparatus), U.S. Pat. No. 6,281,972 (method and apparatus for measuring particle size distribution), U.S. Pat. No. 6,864,979 (particle size distribution measuring apparatus), and the like. The entire disclosure of each of these United States patents is hereby incorporated by reference into this specification.

Referring again to FIG. 1, two mixers (mixer 36 and mixer 38) are shown in the preferred process depicted. Mixer 36 is preferably used to add pigmented coating material to the mineral composition, and is preferably used on darkened headlap material. In any event, it is preferred to feed all of the mineral composition material first to mixer 38 and add (in one embodiment) adhesion promoter material in mixer 38.

In one preferred embodiment, the material obtained from the air separation step contains less than 1 percent of particles greater than 8 mesh (2380 microns), from about 2 to about 10 percent of particles greater than 1,680 microns, less than 2 percent of particles smaller than 420 microns, and less than 1.0 percent of particles (and more preferably less than 0.6% of particles) smaller than 250 microns.

Referring again to FIG. 1, the material fed via lines 34 to mixers 38 and 36 preferably has the desired particle size distribution and a distribution modulus of from about 0.08 to about 0.14. If either or both of these values are not as desired, they may be adjusted by adding to mixer 36 (via line 35) more particulate material After such addition, and appropriate mixing, sampling of the material in mixer 36 may occur in laboratory 32, and the process may be repeated until the desired values have been obtained.

The “distribution modulus” may be determined in accordance with conventional means such as, e.g., the method described in U.S. Pat. No. 6,323,269, the entire disclosure of which is hereby incorporated by reference into this specification.

Once the desired particle size distribution in mixer 36 has been obtained, and after such particles have preferably been pretreated with a pigmented material, one may pass such particles to mixer 38 in which, in one embodiment, one may add a mixture of oil and antistrip agent via line 39 to coat the inorganic particles in such mixer. Alternatively, one may add either the oil alone, or the antistrip agent alone, or neither the oil nor the antistrip agent. The goal, in one embodiment, is to produce a coating on such particulate matter with a thickness of from about 200 to about 2000 nanometers and, preferably from about 300 to about 1200 nanometers.

In one embodiment, the particles are not pretreated with a pigmented material; and the untreated particles are coated with an organic material (such as, e.g., a hydrocarbonoil like naphthenic mineral oil) but not with the amine agent. In another embodiment, the untreated material is coated with both the organic material and the amine agent.

Alternatively, one may add either the oil alone, or the antistrip agent alone, or neither the oil nor the antistrip agent. The goal, in one embodiment, is to produce a coating on such particulate matter with a thickness of from about 200 to about 2000 nanometers and, preferably, from about 300 to about 1200 nanometers. The goal, in another embodiment, is to produce a material wherein the additive(s) is substantially absorbed into the pores of the particles being treated and produces a coating with no or with minimal thickness.

Treating the Particles with a Pigmented Material

In one preferred process, headlap granules are prepared that have one or more of the properties described elsewhere in this specification and, in addition, optionally contain a tinting agent that preferably comprises a pigment and a binder.

Claim 1 of U.S. Pat. No. 7,651,559, the entire disclosure of which is hereby incorporated by reference into this specification, describes, in part, a pigmented material that is comprised, in part, of from about 10 to about 35 weight percent of pigment and from about 90 to about 65 weight percent of a resin (see claim 1). The preparation of this pigmented material, and of the pigments, tinting agents, and resins, are described in columns 38 to 43 of such patent.

In one embodiment, the headlap granules preferably comprise at least about 0.1 weight percent of the tinting agent and, more preferably, from about 0.1 to about 0.8 weight percent of such tinting agent. In one aspect of this embodiment, the headlap granules comprise from about 0.1 to about 0.6 weight percent of the tinting agent. In another aspect of this embodiment, the headlap granules comprise from about 0.15 to about 0.45 weight percent of the tinting agent. In yet another aspect, from about 0.2 to about 0.4 weight percent of the tinting agent is present in the headlap granules.

In one aspect of this embodiment, the tinting agent is present as a coating on the surfaces of the headlap granules; preferably the coating has a thickness of from about 5 to about 15 microns.

In one embodiment, the tinting agent is comprised of from about 10 to about 35 weight percent of a pigment; in another embodiment, the tinting agent is comprised of from about 10 to about 20 weight percent of a pigment. Suitable pigments that may be used are described in columns 39 and 41 of U.S. Pat. No. 7,651,559.

In one preferred embodiment, the inorganic pigment is carbon black. In one aspect of this embodiment, a mixture of carbon black and a resin is prepared by conventional means.

The resin used is preferably a synthetic resin that, e.g., is a film-forming synthetic resin; and processes for preparing mixtures of such synthetic resin and carbon black are well known. Suitable synthetic resins that may be used, and suitable water-soluble resins that may be used, are described at columns 39 to 41 of U.S. Pat. No. 7,651,559.

The mixture of the resin and the carbon black may be prepared by conventional means. Reference may be had, e.g., to U.S. Pat. No. 3,557,040 (process for preparing a carbon black-synthetic resin composition), U.S. Pat. No. 3,563,916 (carbon black-synthetic resins electro-conductive composition), U.S. Pat. No. 3,883,541 (molding powder of aggregates containing carbon black embedded in matrix of vinyl chloride-acetate resin and heat stabilizer), U.S. Pat. No. 3,925,301 (process for the continuous production of carbon black-synthetic resin concentrates), U.S. Pat. No. 4,379,871 (process for the production of carbon black containing pigment-synthetic resin concentrates), U.S. Pat. No. 4,442,160 (electrostatic recording medium having an electrically conductive layer containing pre-dispersed electrically conductive carbon black and polyurethane binder resin), U.S. Pat. No. 4,683,158 (carpet having bottom portions of pile covered with carbon black containing resin), U.S. Pat. No. 4,734,450 (polypropylene-based resin composition containing an inorganic filler and 0.01 to 0.6 weight percent of carbon black), U.S. Pat. No. 5,041,473 (process for producing carbon black filled polyethyelene resins), U.S. Pat. No. 5,207,949 (highly conductive polyoxymethylene resin composition containing carbon black) and the like. The entire disclosure of each of these United States patents is hereby incorporated by reference into this specification.

The tinting agent preferably contains from about 10 to about 35 weight percent of pigment (such as, e.g., carbon black) and from about 90 to about 65 weight percent of resin, both by combined weight of pigment and resin. In one embodiment, the tinting agent contains from about 10 to about 20 weight percent of pigment and from about 90 to about 80 weight percent of resin.

In one embodiment, the tinting agent is made from a water soluble resin and carbon black by the process depicted in FIG. 3. Referring to FIG. 3, and to the process 200 depicted therein, in step 202 the pH of the water used in the process is adjusted so that it is from about 10 to about 11 and, more preferably, from about 10.3 to about 10.7. A sufficient amount of water may be charged to a container (such as, e.g., a beaker) so that when the resin is thereafter charged to the container it will contain from about 20 to about 50 parts of resin, by total weight of resin and water.

One may add ammonia to the water to adjust its pH. Alternatively, or additionally, one may add other pH increasing agents such as, e.g., sodium hydroxide, potassium hydroxide, etc.

Once the pH of the water has been suitably adjusted, one may charge water-soluble resin to the water. One may use one or more of the water-soluble resins known to those skilled in the art. Reference may be had, e.g., to columns 40 and 41 of U.S. Pat. No. 7,651,559.

In one embodiment, the resin used is an ester of pentaerythritol and rosin. These esters are well known and are disclosed, e.g., in U.S. Pat. No. 4,548,746, the entire disclosure of which is hereby incorporated by reference into this specification.

In one preferred embodiment, the resin used is a fumaric modified pentaerythritol ester identified by Chemical Abstracts Registry number 68152-57-8 and sold as “Filtrez 521” by Hexion Specialty Chemicals Inc. of 1202 East Parker Street, Baxley, Ga. 31513.

Referring again to FIG. 3, and to step 204 thereof, the water-soluble curable resin is mixed with the water until it is completely dissolved. In one embodiment, from about 20 to about 50 parts of resin are mixed with about 80 to about 50 parts of water, both by weight. In another embodiment, from about 25 to about 40 parts of resin are mixed with from about 75 to about 60 parts of water. In yet another embodiment, about 30 parts of resin are mixed with about 70 parts of water.

The water used is preferably at ambient temperature, and the resin is added to the water, with stirring, and blended over a suitable period of, e.g., from about 10 to about 15 minutes. Thereafter, the solution thus produced is mixed with the pigment to form a slurry. The pigment (such as, e.g., carbon black) is preferably slowly added and blended with the solution in step 206 until a substantially homogeneous slurry has been produced.

The substantially homogeneous slurry produced in step 206 is then blended with amine-coated headlap granules prepared in step 203. Referring again to FIG. 3, in step 207 the amine-coated limestone granules are coated with the slurry produced in step 206. It is preferred to coat the amine-coated limestone granules with slurry in the same manner (described elsewhere in this specification) in which the uncoated limestone granules were coated with amine, viz.—spraying the coating agent (in this case the slurry, in the prior case the amine) onto the limestone granules as such granules are being transferred through a blending screw. Alternatively, or additionally, other conventional coating processes may be used; thus, e.g., a nebulizing spray mixer may be used.

In this embodiment, the slurry-coated and amine-coated limestone granules are then heat treated in step 209, where they are subjected to a temperature of 130 degrees Centigrade for at least 15 minutes to drive off the water and to cure the tinting agent slurry. The product produced is substantially water insoluble.

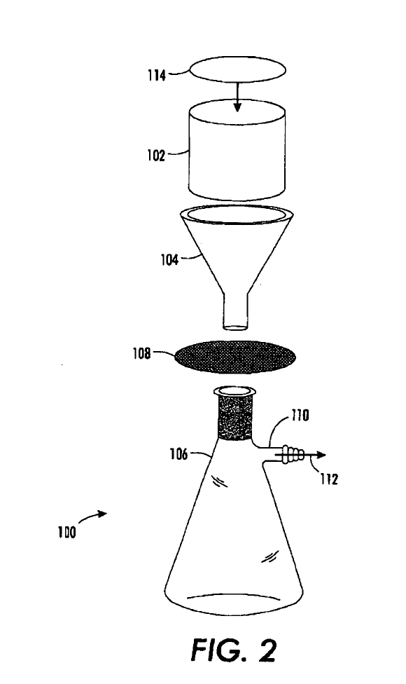

The solubility of the product produced in step 209 of FIG. 3 may be tested in accordance with a process in which 100 grams of such product are disposed in a 500 milliliter beaker in which 375 milliliters of water are then added, and the material is mixed and thereafter boiled for 2 hours. Thereafter, the material is inspected to determine the extent to which, if any, the tinting agent has been removed from the limestone granules. Any of the ink that has separated from the particles will produce turbidity in the water and/or floating black particles in the water and/or material stuck to the surfaces of the beaker. It is preferred that less than about 5 weight percent (and, more preferably, less than about 1 weight percent) of the tinting agent be removed from the coated headlap granules by this test. This process is illustrated in FIG. 2 and is described in more detail in column 25 of U.S. Pat. No. 7,651,559.

Applicant's headlap particles are substantially more resistant to degradation by boiling water than are prior art headlap particles.

### Preferred Adhesion Improving Additives

In U.S. Pat. No. 7,651,559, certain “Preferred Adhesion Improving Additives” are discussed in the disclosure beginning at line 36 of column 16 and extending through line 18 of column 23 of such patent. These adhesion improving additives may be used in the process of the present invention, and they are more briefly described hereinbelow.

FIG. 3 refers to some of these adhesion improving additives in step 209 thereof (“amine coated headlap granules”). FIG. 4 also optionally utilizes some of these additives (“amine antistrip agent”) in its supply tank 404.

### Suitable Adhesion Improving Additives

One may use the adhesion improving additives known to those skilled in the art in, e.g., the process 400 depicted in FIG. 4.

By way of yet illustration, one may use the adhesion improving additives (“antistrip agents”) disclosed in U.S. Pat. No. 4,038,102, the entire disclosure of which is hereby incorporated by reference into this specification. Claim 1 of this patent describes, “1. An additive for improving the adhesion of asphalt to aggregate comprising an ether amine having the general formula: [Figure] wherein: R1 is a hydrocarbon group having from about six to about sixteen carbon atoms, selected from the group consisting of alkyl and alkenyl; R2, r3, r4 and R5 are selected from the group consisting of hydrogen and alkyl radicals having from one to about two carbon atoms; n1 and n2 are numbers within the range from one to about four; x1 and x2 are numbers within the range from zero to about five, the sum of x1 and x2 being from one to five; the total number of carbon atoms in each . . . unit being from one to about four; and an alkanolamine having the formula: . . . wherein: R6 and R7 are selected from the group consisting of hydrogen and alkyl groups having from one to about two carbon atoms; n3 is a number within the range from two to about four; x3 is a number within the range from one to about three; the total number of carbon atoms in each . . . unit being with the range from two to four.” Some of the “ether amines” described by such formula include, e.g., “ . . . octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine.”

By way of further illustration, one may use the amine antistripping agent disclosed in U.S. Pat. No. 4,721,159, the entire disclosure of which is hereby incorporated by reference into this specification. Claim 1 of this patent describes, “1. An asphaltic composition comprising an asphalt admixed with an aggregate and at the interface between said asphalt and said aggregate the reaction product of an amine antistrip and an acid salt in an amount sufficient to bind said asphalt to said aggregate; said acidic salt being a divalent or trivalent metal salt of an inorganic acid.” In the background section of this patent, it is disclosed that, “Various efforts to improve adhesion are detailed in patents such as U.S. Pat. Nos. 2,582,823 and 2,582,824 to Fowkes in which the amine type of antistripping agents or the use of acids and soaps, as well as the use of lime, are discussed and their disadvantages noted. In an attempt to improve these well-known problems, with respect to cut-back asphaltic compositions, there is disclosed a priming solution to be used to attain this better adhesion. For this purpose, Fowkes discloses using alkaline metal salts of certain inorganic acids to form a wet aggregate which is admixed with the cut-back asphalt. Such priming solution does not give the necessary adhesion, does not work with all types of aggregates and does not work satisfactorily with hot-mix asphaltic compositions. Under the press of heavy traffic the resultant compositions crack and lose whatever alleged antistripping function they possess. U.S. Pat. No. 2,469,728 describes another effort to improve the adhesion of the asphalt to the mineral aggregate consisting of mollusk shells in which the shells are first treated with a dilute solution of a strong mineral acid and the thus treated aggregate then coated with asphalt. Here again, such is limited to a cut-back asphalt as set forth in column 1.”

By way of yet further illustration, one may use one or more of the compositions claimed in U.S. Pat. No. 5,064,571, the entire disclosure of which is hereby incorporated by reference into this specification. This patent claims (in claim 1 thereof), “Mixtures of amido-amines prepared by a process comprising reacting at least one first component comprising at least one compound selected from the group consisting of mono- and dicarboxylic acids and acid esters, with a second component comprising polyoxyalkyleneamine bottoms products, where the reaction is conducted in the temperature range from about 25° to about 280° C. and at a pressure in the range from about atmospheric to about 200 psig.”

By way of further illustration, one may use one or more of the hydroxylamines described in U.S. Pat. No. 6,290,772, the entire disclosure of which is hereby incorporated by reference into this specification. This patent claims (in claim 1 thereof), “1. A hydraulic cement composition comprising a mixture of Portland cement and, in an amount of up to 0.1 percent by weight of said cement, an hydroxylamine selected from the group consisting of N,N-bis(2-hydroxyethyl)-2-propanolamine and N,N-bis(2-hydroxypropyl)-N-(hydroxyethyl)amine, said amount being effective to enhance the compressive strength of the cement composition after 1, 3, and 7 days.” In the “background” portion of this patent, some other amines which also may be used are described. It is disclosed that, “Various other additives may be added to cement to alter the physical properties of the final cement. For example, alkanolamines such as monoethanolamine, diethanolamine, triethanolamine and the like are known to shorten the set time (set accelerators) as well as enhance the one-day compressive strength (early strength) of cements. However, these additives have little beneficial effect on the 28-day set strength of the finished cement and in some cases may actually diminish it. This behavior is described by V. Dodson, in “Concrete Admixtures,” Van Reinhold, New York, 1990, who states that calcium chloride, the best known set-time accelerator and early-age strength enhancer reduces compressive strengths at later-ages.”

U.S. Pat. No. 6,290,772 also discloses that “U.S. Pat. Nos. 4,990,190, 5,017,234 and 5,084,103, the disclosures of which are hereby incorporated by reference, describe the finding that certain higher trihydroxyalkylamines such as triisopropanolamine (hereinafter referred to as “TIPA”) and N,N-bis(2-hydroxyethyl)-2-hydroxypropylamine (hereinafter referred to as “DEIPA”) will improve the late strength (strength after 7 and 28 days of preparation of the wet cement mix) of Portland cement, especially Portland cements containing at least 4 percent C4 AF. The strength-enhancing higher trihydroxyalkylamine additives described in these patents are said to be particularly useful in blended cements.”

By way of yet further illustration, one may use one or more of the “organic modifiers” disclosed in U.S. Pat. No. 6,503,740, the entire disclosure of which is hereby incorporated by reference into this specification. Claim 1 of this patent describes, “1. A self-cleaning treatment media capable of acting upon at least one chemical contaminant in an aqueous composition assisting in the decomposition of that contaminant to at least one suitable lower molecular weight compound, the treatment media comprising: a mineral-based substrate present in granular form, the mineral-based substrate being a charged material selected from the group consisting of clays, clay analogs, synthetic resins and mixtures thereof; a compound capable of providing organic surface modification to a portion of the mineral-based substrate, the organic modification compound comprising quaternary amines, wherein the quaternary amines are selected from the group consisting of ditallow dimethyl ammonium chloride, hexadecyl ammonium chloride, octadecyl ammonium chloride, di-methyl di-hydrogenated tallow ammonium chloride, dicocodimethyl ammonium chloride, and mixtures thereof, and wherein the mineral-based substrate contains the organic modification compound; and at least one strain of microbial material engrafted on the surface of the mineral-based substrate containing the organic surface modification compound, the microbial material capable of facilitating decomposition of the at least one chemical contaminant in the aqueous composition; wherein the strain of microbial material has a biological activity, and wherein the organic surface modification compound is one which permits sufficient biological activity of the microbial material when the microbial material and the organic surface modification compound are both present on the mineral-based substrate.”

U.S. Pat. No. 6,503,740 also discloses how to modify the mineral-based substrate, stating that, “The manner in which organic modification occurs can be by any method known to those skilled in the art. Heretofore, it was believed that quaternary amines used to modify the surfaces of the substrates such as those discussed previously were biocidal and would de-activate bacterial material which came into contact with the amine material. The present invention is predicated on the unexpected discovery that specific classes of quaternary amines are non-biocidal to target bacteria. Indeed, it has been found that the quaternary amines employed in the present invention provide actual enhancement to the bacterial colonies inoculated on the surface of the clay or mineral material. Without being bound to any theory, it is believed that this is due to the ability of the quaternary amine material to provide alcoholic materials such as isopropyl alcohol in nutrient level concentration when the quaternary amine is employed to organically modify the substrate materials; particularly those specified in the foregoing discussion.”

U.S. Pat. No. 6,503,740 also discloses that, “The quaternary amine employed in the process of the present invention is one which will be biologically supportive of inoculated bacteria, i.e., not adversely affect bacterial activity when the quaternary amine is employed to provide organically modified clays and mineral materials. The preferred quaternary amine can be generally characterized as an ammonium compound having 12 to 18 carbon atoms. The quaternary amines employed in the present invention are preferably selected from the group consisting of organically modified hydrogenated tallow ammonium chlorides, ditallow dimethyl ammonium chloride, hexadecyl and octadecyl ammonium chloride and derivatives thereof. Most preferably, the quaternary amine is selected from the group consisting of di-methyl di-hydrogenated tallow ammonium chloride, dicocodimethyl ammonium chloride, and mixtures thereof.”

U.S. Pat. No. 6,503,740 also discloses that, “In the preferred embodiment, the quaternary amine of choice is employed at a ratio sufficient to provide organic modification without adversely affecting biological activity of the target microbes or their ability to graft on the available surface of the mineral material. The preferred range of quaternary amine to clay or mineral material is between about 10% to 100% amine to clay or mineral respectively, with a range between about 10% to 45% and about 10 g to 100 g being preferred; and ranges between about 36 g to 100 g, and 48 g to 100 g being most preferred. In a preferred embodiment, the mineral-based substrate and the organic surface modification compound are present in a ratio between about 10 parts to about 100 parts; and about 5 parts to about 150 parts, surface modification compound to mineral-based substrate respectively.”

U.S. Pat. No. 6,503,740 also discloses that, “In order to prepare the biologically activated organically modified mineral material of the present invention, quantities of the mineral or clay substrate material or resin and quaternary amine material are blended in any suitable manner, in the proportions defined above, together with precultured bacteria in an aqueous medium. Blending may be accomplished by various devices such as a ribbon blender, extruder or the like. Particulars about the production of organically modified clays are generally known in the art and are as outlined in U.S. Pat. No. 4,402,881 issued to Alther, which is incorporated by reference herein in its entirety. After suitable mixing, the resulting material which typically has a slurry-like consistency is dried and either milled to a powder or granulated.”

U.S. Pat. No. 6,503,740 also discloses that, “During the mixing process, nitrogen supplying nutrients such as standard fertilizer, urea and the like or carbon/glucose supplying nutrients such as molasses and alcohol can be incorporated. If necessary, oxygenated material can also be incorporated by including slow-release sources of oxygen such as calcified seaweed or marl. Trace minerals can also be incorporated.”

By way of further illustration, U.S. Pat. No. 6,786,963, the entire disclosure of which is hereby incorporated by reference into this specification, discloses certain diamide compounds that may be used in the process of the instant invention. Claim 1 of this patent describes “1. A paving composition comprising a bituminous material and a diamide compound, wherein: the composition is substantially free of water; and the diamide compound is represented by: [Figure] if A is hydrogen, B is R2 NHR3 NH2; if A is R2 NH2, B is R3 NH2; R1 is a branched or straight-chain alkyl or aromatic or alkylaromatic group; and R2 and R3 are the same or different and are a branched chain alkyl, straight-chain alkyl, or —R—NH—R, in which R is a branched chain alkyl with about 1 to about 6 carbon atoms or a straight-chain alkyl with about 1 to about 6 carbon atoms.” This patent also discloses that, in its background section, that “Asphalt compositions have relatively poor adhesion to mineral aggregates in the presence of water. Since the aggregate is preferentially wetted by water, even if the aggregate is dry at the time it is blended with the asphalt, the eventual penetration of water into the composition reaches the aggregate and interferes with the bond between the aggregate and the asphalt. The result of this stripping is flaked pavement and potholes. Stripping problems also generally occur if the aggregate is poorly dried, if sandy carbonate aggregate containing a large amount of quartz particles is used, if carbonate aggregate is covered with dust, or if igneous (silicate) aggregates, such as granite, diorite, gabbro, diabase, or basalt, that strip in the presence of external water are used. To avoid such failures, adhesion-improving agents known as “anti-stripping agents” are commonly added to the asphalt. Before the mixing operation, these agents are added to the bituminous binder to reduce its surface tension and to induce on the binder an electrical charge opposite to that of the aggregate surface. Lower surface tension gives improved wettability of the aggregate, and charge reversal enhances bond strength by increasing Coulomb's attractive forces.”

U.S. Pat. No. 6,786,963 also discloses that, “Cationic substances, particularly amines, have been traditionally used as anti-stripping agents. The cationic substances increase the hydrophobicity of the aggregate, making the aggregate resistant to the penetration of water so that water seeping into the asphalt does not tend to destroy the bond between the asphalt and the aggregate. The addition of the cationic substances tends to make the aggregate sufficiently water resistant that a good bond with the asphalt is formed. Among the cationic materials which have been used as adhesion promoters with asphalt, are primary alkyl amines (such as lauryl amine and stearyl amine) and alkylene diamines (such as the fatty alkyl substituted alkylene diamines). Because these amines may rapidly lose their activity when combined with asphalt and stored at elevated temperatures for an extended period, it has therefore been necessary to combine the amine with the asphalt at the work site when the asphalt is combined with the aggregate, which in practice presents difficulties in obtaining a homogeneous mixture. It is also noted that these amines are generally corrosive and may have an unpleasant smell.”

U.S. Pat. No. 6,786,963 also discloses that, “Various asphalt formulations have been reported in attempts to enhance the properties of paving compositions while avoiding the above-described difficulties. U.S. Pat. No. 4,447,269 offers cationic oil in water type bituminous aggregate slurries. The emulsion comprises bitumen and a reaction product of a polyamine and a polycarboxylic acid, and water. Lime or cement can be added to reduce the setting time of the mixture.”

As is also disclosed in U.S. Pat. No. 6,786,963, “U.S. Pat. No. 4,721,529 suggests the preparation and use of asphalt admixtures with the reaction product of an amine antistrip and an acid salt. The acid salt is a divalent or trivalent metal salt of an inorganic acid. U.S. Pat. No. 5,443,632 suggests cationic aqueous bituminous emulsion-aggregate paving slurry seal mixtures. The emulsifier is the product of reaction of polyamines with fatty acids and rosing, and a quaternizing agent. U.S. Pat. No. 4,806,166 proposes preparation of an aggregate comprising asphalt and an adhesion improving amount of an anti-stripping agent comprising the aminoester reaction product of a tall oil fatty acid and triethanolamine. The reaction product is of low viscosity, has good coating performance, and is inexpensive. U.S. Pat. No. 5,019,610 offers an asphalt composition comprising a blend of a thermoplastic rubber polymer and a fatty dialkyl amide, and asphalt cement. The preparation method requires only gentle stirring. The amide has a C6-C22 alkyl group attached to the carbonyl, and two C1-C8 alkyl groups attached to the amide nitrogen. The compositions offer good viscosities at relatively low residue percentages. The compositions are offered for use in road paving, asphalt roofing cements, mastics, moisture barriers, joint and crack fillers, and sheeting.”

U.S. Pat. No. 6,786,963 also discloses that “U.S. Pat. No. 4,430,127 suggests preparation of a bitumen and epoxylated polyamine composition. The compositions provide improved adhesion between aggregate materials and the bitumen material. At least two of the amino nitrogen atoms are separated by six carbon atoms. U.S. Pat. No. 4,462,840 proposes use of a cation-active emulsifier which is the product of a polyamine and polycarboxylic acids. The emulsifier is useful in producing aqueous bituminous emulsion-aggregate slurries.”

By way of yet further illustration, U.S. Pat. No. 6,875,341 describes and claims the use of certain antistrip agents; the entire disclosure of this United States patent is hereby incorporated by reference into this specification.

Claim 11 of U.S. Pat. No. 6,875,341 describes, “11. A process for extraction of selected heteroatom-containing compounds from hydrocarbonaceous oil for use in commodity, specialty or industrial applications, the process comprising contacting the hydrocarbonaceous oil with a mixture of polar solvent and water to selectively recover heteroatom-containing compounds into an extract fraction that contains low concentrations of non-heteroatom-containing compounds by use of a solvent and water mixture in a ratio to achieve a coefficient-of-separation of heteroatom-containing compounds that is greater than 65%, where the coefficient of separation is the mole percent of heteroatom-containing compounds from the carbonaceous oil that are recovered in the extract fraction minus the mole percent of non-heteroatom-containing compounds from the carbonaceous oil that are recovered in the extract fraction.” An antistrip agent made via this process is identified in claim 12, which states, “12. The process of claim 11 wherein the extracted fraction containing high concentrations of heteroatom-containing compounds and low concentrations of non-heteroatom-containing compounds is used with little or no further processing as an antistrip asphalt additive . . . . ”. Similarly, claim 13 of U.S. Pat. No. 6,875,341 discusses, “13. The process of claim 11 wherein the extracted fraction containing high concentrations of heteroatom-containing compounds and low concentrations of non-heteroatom-containing compounds is used as a feedstock for manufacture of surfactants, pyridine N-oxides, quaternary pyridinium salts, asphalt antistrip additives . . . . ”

By way of yet further illustration, one may use one or more of the antistrip agents disclosed in U.S. Pat. No. 4,839,404 (bituminous compositions having high adhesive properties), U.S. Pat. No. 4,933,384 (bituminous materials), U.S. Pat. No. 4,975,476 (bituminous materials), U.S. Pat. No. 5,352,275 (method of producing hot mix asphalt), U.S. Pat. No. 5,558,702 (asphalt emulsions containing amphoteric emulsifier), U.S. Pat. No. 5,566,576 (asphalt emulsions), U.S. Pat. No. 5,660,498 (patching system and method for repairing roadways), U.S. Pat. No. 5,667,577 (filled asphalt emulsions containing betaine emulsifier), U.S. Pat. No. 5,755,865 (asphalt rejuvenator and recycled asphalt composition), U.S. Pat. No. 5,766,333 (method for recycling and rejuvenating asphalt pavement), U.S. Pat. No. 6,093,494 (antistrip latex for aggregate treatment), U.S. Pat. No. 6,403,687 (antistrip latex for aggregate treatment), and the like. The entire disclosure of each of these United States patents is hereby incorporated by reference into this specification.

In one preferred embodiment, the antistrip agent is an organic amine, which may be primary, secondary, or tertiary, and which contains from about 1 to about 18 carbon atoms.

In one preferred embodiment, the antistrip agent is an amido-amine (fatty acid amine).

In one preferred embodiment, the antistrip agent is comprised of 4,4′-methylenebiscyclohexanamine. In another embodiment, the antistrip agent is comprised of mixed polycycloaliphatic amines.

In one preferred embodiment, in addition to or instead of the antistrip agent, one may use an adhesion-promoting agent, such as, e.g., the adhesion agents described in U.S. Pat. No. 5,240,760, the entire disclosure of which is hereby incorporated by reference into this specification. As is disclosed in this patent (see from line 56 of column 4 to line 38 of column 5), “Suitable adhesion agents are compound(s) capable of promoting the adhesion of roofing granules to an asphalt-based substrate. Preferred adhesion agents are hydrophobic in nature, and do not significantly alter the color of the roofing granules. The adhesion agent should be compatible with the polysiloxane and the roofing granules' surfaces. Preferred adhesion agents are silicones other than those that have long-chain hydrocarbon groups. Preferred silicones are described in E. Schamberg, Adhesion, v. 29(11), pp. 20, 23-27 (1985), as well as in U.S. Pat. Nos. 4,486,476, 4,452,961, 4,537,595 and U.S. Pat. No. 4,781,950. These kinds of silicones can be purchased under the trademark TEGOSIVIN (particularly TEGOSIVIN HL100) from Goldschmidt Chemical Corporation, Hopewell, Va.”

U.S. Pat. No. 5,240,760 also discloses that, “Other adhesion agents that can be suitable include resin compositions R-20, R-24, R-27, R-270, and R-272, (Union Carbide Corporation, Danbury, Conn.), Wacker Silicone Resins MK, M-62 (Wacker-Chemi GMBA, Alemania, Germany), Dri-Sil.™.73, Dow Corning 1107, Dow Corning 477 Resin (Dow Corning Corporation, Midland, Mich.), SR-82 and SM 2138 available from General Electric, Schenectady, N.Y., and oleic acid, Witco Chemical Corporation, Chicago, Ill. Mixtures or combinations of adhesion agents may be employed.”

U.S. Pat. No. 5,240,760 also discloses that, “The adhesion agent is employed on the roofing granules' surfaces to an extent sufficient to promote granule adhesion to an asphalt-based substrate. The amount of adhesion agent can vary depending on the composition of the roofing granules and adhesion agent. Generally speaking, adhesion agents are employed at about 0.01 to 5 pounds per ton of roofing granules (5×10-4 to 0.25 weight percent). In the case of TEGOSIVIN silicones noted above, the adhesion agent is preferably applied to the roofing granules at about 0.5 to 1 lb. per ton of granules (2.5×10-3 to 0.05 weight percent), more preferably at 0.1 to 0.3 pound per ton (0.005 to 0.015 weight percent).”

U.S. Pat. No. 5,240,760 also discloses that, “The polysiloxane and adhesion agent are preferably applied to the roofing granules as solutes in an oil solvent. The oil assists in spreading the polysiloxane and adhesion agent to the roofing granules' surfaces, and also helps reduce dust formation.”

U.S. Pat. No. 5,240,760 also discloses that, “When using an oil to apply the adhesion agent and polysiloxane to roofing granules' surfaces, the oil is employed at up to about 12 pounds per ton of roofing granules (0.6 weight percent) based on the weight of roofing granules, preferably 1 to 10 pounds per ton (0.05 to 0.5 weight percent), and more preferably 5 to 8 pounds per ton (0.25 to 0.4 weight percent).”

U.S. Pat. No. 5,411,803, the entire disclosure of which is hereby incorporated by reference into this specification, also describes adhesion agents. As is disclosed in such patent, “Adhesion to bituminous surfaces is also improved using ZFP and borate compounds. Adhesion is described in terms of wet and dry “pick tests,” which are described in detail in the Test Methods Section. The dry and wet pick values have units of percent (%), with a higher number indicating better adhesion, a low number indicating cohesive failure of the bituminous surface to which the granule is adhered, rather than adhesive failure of the granule from the surface. Preferred values for dry pick are at least about 75%, whereas for wet pick the value is at least about 50%, more preferably at least about 70%.” (See column 7, lines 3-14.)

These adhesion improving additives, and others, are discussed in columns 16 through 23 of U.S. Pat. No. 7,651,559, the entire disclosure of which is hereby incorporated by reference into this specification.

Referring again to FIG. 1, and in the preferred embodiment depicted therein, the antistrip agent (and/or the adhesion agent) is preferably mixed in mixer 36 with the particulate material (from line 34) and, optionally, with an oil, such as, e.g., a naphthenic mineral oil. In one embodiment, the use of the antistrip agent is omitted, and only the oil is applied as a coating. In another embodiment, the use of the oil is omitted, and only the antistrip agent is applied as a coating. In yet another embodiment, neither such oil nor such antistrip agent is utilized.

In this embodiment, the oil used may be, e.g., a “hydrocarbon oil,” as that term is defined in U.S. Pat. No. 6,358,305, the entire disclosure of which is hereby incorporated by reference into this specification. At column 4 of U.S. Pat. No. 6,358,305, certain “hydrocarbon oils” are described; one or more of these “hydrocarbon oils” may be used in conjunction with the “antistrip agent” described elsewhere in this specification (or by itself) to prepare coated limestone granules. At lines 47-54 of such column 4, it is disclosed that, “The hydrocarbon oils employed in the compositions of the present invention may be either synthetic or natural in origin. These oils, referred to as process oils, can be obtained from petroleum, coal, gas and shale. The oils are of the lubricating oil viscosity range, typically in a 300 c.p. viscosity range. These hydrocarbon oils are often referred to as process oils and are available from several companies, such as Ergon Inc., Arco and Cross Oil Co.”

The hydrocarbon oil used may be, e.g., one or more naphthenic mineral oils, and/or a paraffinic mineral oil, and/or a plant oil, and/or an animal oil.

Naphthenic mineral oils are preferred in one embodiment. These naphthenic mineral oils contain a significant proportion of naphthenic compounds, and they are well known to those skilled in the art. Reference may be had to the following United States patents which refer to “napthenic mineral oil” in their claims: U.S. Pat. No. 3,980,448 (organic compounds as fuel additives), U.S. Pat. No. 4,101,429 (lubricant compositions), U.S. Pat. No. 4,180,466 (method of lubrication of a controlled-slip differential), U.S. Pat. No. 4,324,453 (filling material for electrical and light waveguide communications cables), U.S. Pat. No. 4,374,168 (metalworking lubrication), U.S. Pat. No. 4,428,850 (low foaming lubricating oil compositions), U.S. Pat. No. 4,510,062 (refrigeration oil composition), U.S. Pat. No. 4,676,917 (railway diesel crankcase lubricant), U.S. Pat. No. 4,720,350 (oxidation and corrosion inhibiting additives for railway diesel crankcase lubricants), U.S. Pat. No. 4,793,939 (lubricating oil composition containing a polyalkylene oxide additive), U.S. Pat. No. 4,781,846 (additives for aqueous lubricant), U.S. Pat. No. 5,460,741 (lubricating oil composition), U.S. Pat. No. 5,547,596 (lubricant composition for limited slip differential of a car), U.S. Pat. No. 5,658,886 (lubricating oil composition), U.S. Pat. No. 6,063,447 (process for treating the surface of metal parts), U.S. Pat. No. 6,245,723 (cooling lubricant emulsion), U.S. Pat. No. 6,482,780 (grease composition for rolling bearing), U.S. Pat. No. 6,736,991 (refrigeration lubricant for hydrofluorocarbon refrigerants), and the like. The entire disclosure of each of these United States patents is hereby incorporated by reference into this specification.

When both the oil and the antistrip agent is used, it is preferred that the ratio of the oil/antistrip agent used is from about 10/90 to about 90/10 weight percent. In one embodiment, from about 0.25 to about 1.0 pounds of such oil is added for each 2,000 pounds of the limestone granules in mixer 45. In another embodiment, from about 0.25 to about 1.0 pounds of a mixture of such oil and one or more of the aforementioned antistrip agent is added for each 2,000 pounds of the limestone granules in mixer 45.

In another embodiment, from about 1 to about 3 parts of oil are preferably used for each part of the antistrip compound. In one aspect of this embodiment, from about 1.5 to about 2.5 parts of oil are used for each part of the antistrip compound.

In one embodiment, from about 0.5 to about 2.0 gallons of such oil, and from about 0.5 to about 1.0 gallons of such antistrip compound are added for each ton of the limestone granules.

In one embodiment, a sufficient amount of oil and/or adhesion improving agent agent is charged via line 39 to form a coating on the particulate matter in mixer 38 that is from about 200 to about 2,000 nanometers and, preferably, from about 300 to about 1200 nanometers; and, within such mixer, it preferably is sprayed onto the particulate matter in the manner described elsewhere in this specification.

In one preferred embodiment, a blend of the oil and the antistrip compound is sprayed onto the limestone granules (from “line 40”) as such granules are being transferred through a blending screw. The rate of addition is preferably based on the rate of the atomizer as it relates to the rate of the material being transferred through the blending screw.

In one preferred embodiment, and referring again to FIG. 1, from about 0.001 to about 4 parts (by weight) of such oil, and from about 0.001 to about 4 parts (by weight) of such antistrip agent, are charged to mixer 38 for each 100 parts of particulate in such mixer. In one aspect of this embodiment, less than 2 weight percent of each of the oil and the antistrip agent are used. In another aspect of this embodiment, less than 1 weight percent of each of the oil and the antistrip agent are used. In yet another embodiment, less than about 0.5 weight percent of each of the oil and the antistrip agent are used.

In one embodiment, the oil and the antistrip agent are preferably mixed in mixer 38 which, in one aspect of this embodiment, is comprised of a blending screw. One may use any of the blending screws known to those skilled in the art. Reference may be had, e.g., to U.S. Pat. No. 3,881,708 (mixing extruders), U.S. Pat. No. 3,938,469 (apparatus for coating particulate material with finely divided solids), U.S. Pat. No. 5,573,331 (multiple-stage screw for blending materials), and the like. The entire disclosure of each of these United States patents is hereby incorporated by reference into this specification.

Samples may be periodically withdrawn from the mixer 38 via line 42 to be tested in laboratory 32 and to determine whether the coated particles have met the specifications for the roofing granules.

In one embodiment, illustrated in FIG. 1, the aforementioned antistrip agent and/or oil are charged to mixer 38 via line 39. In this embodiment, the particles from air flow separator 30 are charged directly via line 34 to mixer 38.

In another embodiment, illustrated in FIG. 1, the particles from air flow separator 30 are charged via line 34 to mixer 36, but a mixture of pigment and binder is added to mixer 36. The pigmented particles produced in mixer 36 are then charged via line 40 to mixer 38, wherein the antistrip agent and/or oil is added via line 39. Thereafter, the particles so treated are fed via line 44 to mass flow silo 46.

In one embodiment, the coated particles of this invention are tested to determine whether they have the required degree of hydrophobicity. One may utilize the assembly 100 depicted in FIG. 2 for this purpose.

Referring to FIG. 2, and in the preferred embodiment depicted therein, the assembly 100 tests material for its ability to resist moisture adsorption, in accordance with the procedure described below. Prior to conducting the test, all of the materials and the equipment are preferably dried until they are substantially moisture free.

Utilizing a 5.5 centimeter round flat bottomed filter case 102 and an accompanying fitted funnel bottom 104, one may assemble the apparatus depicted onto a rubber-stoppered Buchner flask 106. In the embodiment depicted, a rubber disk 108 is preferably disposed on top of the Buchner flask 106 in order to seal the vacuum applied to such flask.

Referring again to FIG. 2, the vacuum is pulled through port 110 in the direction of arrow 112 via a vacuum pump (not shown). While a vacuum is pulled on the apparatus via a vacuum pump (not shown), a filter pad 114 (such as, e.g., a Whatman 40 gravimetric analysis filter pad) is wetted with water until it is fully wetted. Thereafter, the vacuum is allowed to remove free moisture from the filter pad.

Thereafter, the flat-bottomed filter case 102 and wetted filter pad are removed, and any free moisture from the bottom side of the filter assembly is also removed. The assembly is weighed, and the weight is recorded. Fifty (50) grams of the granular material to be tested is weighed to the nearest 100^{th} of a gram. This material is then transferred to the filter assembly without moving the filter pad on the bottom of the assembly, and the 50 grams of material are gently tapped to flatten out the sample. Thereafter, 100 grams of distilled water are weighed to the nearest 100^{th} of a gram; and the 100 grams of water are carefully poured (to avoid causing dimpling of the sample) onto the 50 grams of material which has been assembled back onto the top of the funnel assembly and is under vacuum. The vacuum is allowed to continue pulling the water through the material and through the filter pad. When the water stops coming from the filter (end point is reached when water is not visible on top of the sample and water has stopped being seen on the end of the funnel assembly for 30 seconds), the vacuum is broken and the filter assembly removed from the funnel assembly. Free moisture is then removed from the bottom of the filter assembly. The filter assembly and the wet sample are then weighed again, and the weight is recorded. The weight of the final assembly minus the (weight of dry filter assembly and wetted filter+weight of sample) is equal to the amount of water adsorbed onto the surface of the sample. This final weight of absorbed water is the reported value and can be reported as an absolute value or as a percentage of the weight of the sample being tested.

When this test is performed on treated and untreated limestone granules in the 10-30 mesh range, the untreated limestone will often absorb about 2.6 grams of water (which is 4.2 percent of the weight of the 50 gram sample). Some embodiments of the treated limestone, by comparison, will often absorb only 1.05 grams, which is only 2.1 weight percent of the 50 gram sample; other embodiments of the treated limestone have even greater degrees of hydrophobicity.

It is preferred that the granules of this invention has a hydrophobicity of less than about 3.0 percent and, more preferably, less than about 2.5 percent. In one aspect of this embodiment, the granules have a hydrophobicity of less than about 2.0 percent and, more preferably, less than about 1.5 percent.

Spraying the Additive onto the Granular Particles

In one embodiment, the additive used is naphthenic mineral oil, it acts as an adhesion improving agent, and such oil is preferably in a liquid form that is sprayed onto the particles. If such oil is not in a liquid phase, it is converted to a liquid phase prior to the time it is sprayed onto the granular material.

As used herein, the term “sprayed” includes the term “nebulized, and it refers to any process step in which the oil additive is formed into an aerosol of fine droplets before they are applied to the surfaces of the particles being coated. Without wishing to be bound to any particular theory, applicant believes that, unless the oil is applied by spraying, the coated particle thus produced will not have adequate adhesion properties.

The additive may be sprayed by conventional methods such as, e.g., those described on pages 18-58 to 18-65 of Robert H. Perry et al.'s “Chemical Engineers Handbook,” Fifth Edition (McGraw Hill Book Company, New York, N.Y. 1973).

Thus, e.g., and as is disclosed in the Chemical Engineers Handbook, one may use spray nozzles such as, e.g., the nozzles illustrated in FIG. 18-112 and Table 18-21 of such handbook.

Thus, e.g., one may use the nebulizer described in U.S. Pat. No. 6,705,312, the entire disclosure of which is hereby incorporated by reference into this specification. This patent describes a device that has a main body containing a vibrating element, electronic circuitry, and a battery for powering the circuitry and the vibrating element. An atomizer is provided on top of the main body, and it is suitably coupled to the electronic circuitry and the vibrating element to allow for the atomization of liquid.

Thus, e.g., one may using the spraying process described in U.S. Pat. No. 6,966,610, the entire disclosure of which is hereby incorporated by reference into this specification. As is disclosed in such patent, “the spraying may be carried out by the use of a spray gun for example Hot Shot Adhesive gun available from Sericol Limited of the United Kingdom which uses compressed air at up to 10 bar . . . . Power HB spray melt, a spray gun available from Power Adhesives Limited of the United Kingdom is also suitable for use in the present invention. The gun uses compressed air at up to 8 bar . . . . The spraying may conveniently be carried out using a hand held spray gun provided with an electrically heated compartment for the adhesive and means for supplying air under pressure to the molten adhesive to assist the spraying. Instead of the gun being hand held, the adhesive may be automatically applied using an automatic spray gun or other applicators.”

One may use a nebulizer such as, e.g., the ultrasonic nebulizer described in U.S. Pat. No. 7,673,812, the entire disclosure of which is hereby incorporated by reference into this specification. Claim 1 of this patent describes: “A portable ultrasonic nebulizer apparatus for automatically adjusting an operation frequency of the apparatus corresponding to a resonant frequency, comprising: a power supply for supplying power; vibrating element to vibrate a liquid to form an aerosol of fine droplets; a variable oscillator for providing a plurality of frequencies to the vibrating element so as to let the vibrating element vibrate at the plurality of frequencies; a step-up converter electrically connected with the variable oscillator for converting an input voltage to a boosted voltage to the vibrating element; a current detecting element positioned between the power supply and the vibrating element for detecting a plurality of electrical current values passing before the vibrating element, the value being respectively related to each of the plurality of frequencies; and a microprocessor for receiving the plurality of electrical current values related to each of the plurality of frequencies so as to determine the resonant frequency at which the electrical current is a maximum value and adjusting the operation frequency of the vibrating element provided by the variable oscillator corresponding to the resonant frequency.”

One may spray the additive onto the limestone granules by the process described in U.S. Pat. No. 7,611,753, the entire disclosure of which is hereby incorporated by reference into this specification. Claim 1 of this patent discloses: “1. A process comprising impregnating a porous mineral substrate with a liquid impregnating agent, wherein the impregnating comprises spraying the liquid impregnating agent and a gas from a gas-supported spraying assembly; and the liquid impregnating agent is sprayed from the gas-supported spraying assembly at a pressure of at most 2 bar gauge, wherein the gas-supported spraying assembly comprises a nozzle system comprising one or more nozzles; the liquid impregnating agent and the gas are fed into each of the one or more nozzles at a pressure of at most 2 bar gauge; and the gas atomises the liquid impregnating agent in each of the one or more nozzles, wherein the liquid impregnating agent is substantially free of solvent.

One may deposit the additive onto the limestone granules by means of the plasma spraying device disclosed in published United States patent application 20080057212, the entire disclosure of which is hereby incorporated by reference into this specification. Claim 1 of this published patent application describes: “Plasma spraying device for spraying a coating . . . onto a substrate . . . by a thermal spray process, said plasma spraying process including a plasma torch . . . for heating up a plasma gas . . . in a heating zone . . . , wherein the plasma torch . . . includes a nozzle body . . . for forming a plasma gas stream . . . , said plasma torch . . . having an aperture . . . running along a central longitudinal axis . . . through said nozzle body . . . which aperture . . . has a convergent section . . . with an inlet . . . for the plasma gas . . . , a throat section . . . including a minimum cross-sectional area of the aperture, and a divergent section . . . with an outlet . . . for the plasma gas stream . . . , wherein an introducing duct . . . is provided for introducing a liquid precursor . . . into the plasma gas stream . . . , characterized in that a penetration means . . . is provided to penetrate the liquid precursor . . . inside the plasma gas stream . . . . ”

One may deposit such additive onto the limestone granules by means of the heated nebulizer device disclosed in published United States patent application 20100258114, the entire disclosure of which is hereby incorporated by reference into this specification. Claim 1 of this published patent application describes: “1. A nebulizer assembly comprising: a reservoir for containing a liquid; a nebulizer for producing an aerosolized gas using the liquid; an aerosolized gas outlet coupled to the nebulizer to pass the aerosolized gas; and a heating chamber disposed around an exterior of the reservoir, wherein the heating chamber includes a heating fluid inlet in fluid communication with the heating chamber for providing heating fluid to the heating chamber and a heating fluid outlet in fluid communication with the heating chamber for discharging the heating fluid from the heating chamber.”

In one embodiment, the additive is heated to a temperature greater than ambient prior to the time it is sprayed onto the granular material. In another embodiment, the granular material is heated to a temperature greater than ambient prior to the time the additive is sprayed onto it. In either case, it is preferred to agitate the granules during spraying in order to expose as many granular surfaces as possible to the spray.

In one embodiment, and referring again to FIG. 1, from about 0.001 to about 4 parts (by weight) of such oil, and from about 0.001 to about 4 parts (by weight) of such amine are charged to mixer 38 for each 100 parts of particulate in such mixer.

In one embodiment, the oil and the amine agent are preferably mixed in mixer 38 which, in one aspect of this embodiment, is comprised of a blending screw. Samples may be periodically withdrawn from the mixer 38 via line 42 to be tested in laboratory 32 and to determine whether the coated particles have met the specifications for the roofing granules.

In one aspect of this embodiment, the aforementioned amine agent and/or oil are charged to mixer 38 via line 39. In this embodiment, the particles from air flow separator 30 are charged directly via line 34 to mixer 38.

In another embodiment, illustrated in FIG. 1, the particles from air flow separator 30 are charged via line 34 to mixer 36, but a mixture of pigment and binder is added to mixer 36. The pigmented particles produced in mixer 36 are then charged via line 40 to mixer 38, wherein the amine agent and/or oil is added via line 39. Thereafter, the particles so treated are fed via line 44 to mass flow silo 46.

### Another Preferred Process of the Invention

In one embodiment, the roofing granules of this invention are made in substantial accordance with the procedure described with reference to FIGS. 1 and 3, with several modifications.

In the first place, two mixers are used (see, e.g., mixer 36 and mixer 38 depicted in FIG. 1). It is preferred to charge the particles from air flow separator 30 to mixer 36 via line 34 and, while such particles are in such mixer, mix them with the pigment and binder mixture described in this specification. In one aspect of this embodiment, the amine agent and/or the oil are not charged to mixer 36 but are thereafter charged to mixer 38. Thus, the difference in this new embodiment is that the pigment and binder mixture are charged and mixed with the particles prior to the time they are contacted with either the amine adhesion improving agent and/or the oil.

In one aspect of this embodiment, the mixer 36 is heated such that, during the mixing of the particles with the pigment/binder mixture, such particles are preferably heated to a temperature of at least about 130 degrees Celsius for at least about 15 minutes. In one aspect of this embodiment, such particles are heated to a temperature of at least about 130 degrees Celsius for at least about 22 minutes.

In this embodiment, one may use the same pigments and/or binders as has been described elsewhere in this specification. Alternatively, one may replace soe or all of the binder described hereinabove with a film forming binder.

As is known to those skilled in the art, a film forming binder is a material that forms a polymeric surface which encapsulates the particles with which it is in contact. Reference may be had, e.g., to U.S. Pat. No. 5,079,037 (resistive films comprising resistive short fibers in insulating film forming binder), U.S. Pat. No. 5,516,458 (coating composition containing film forming binder), and U.S. Pat. No. 6,096,835 (coating composition containing film forming binder), Reference also may be had to published United States patent applications US2003/013050 (coating composition containing polythiophene and film-forming binder) and US2005/0029496. The entire disclosure of each of these United States patents and published patent applications is hereby incorporated by reference into this specification.

In one embodiment, the mineral composition of this invention is coated with a film forming binder containing a pigment. The desired effect of this pigment-binder system is to coat the exposed surfaces of the granules wherein the cured coating surface is not readily stripped away by additional processing or by heating during processing.

When such film forming binder is used, it is preferred to mix such binder with the pigment described elsewhere in this specification to produce a mixture that preferably comprises from about 15 to about 20 weight percent of such binder, from about 15 to about 20 weight percent of such pigment, and one or more solvents. The solvent used is preferably an aqueous solvent that comprises water.

In one embodiment, a pigment is used to produce a black color with certain L*a*b* values. These L*a*b* values may be measured using the “Lab color space system.”

As is known to those skilled in the art, “Lab” is the abbreviated name of two different color spaces, the best known of which is “CIELAB” (also referred to as “CIE 1976 L*a*b*”); and it is discussed at columns 44 and 45 of U.S. Pat. No. 7,651,559.

Referring again to FIG. 1, the binder, pigment, and water are preferably present in the form of an aqueous slurry, and such slurry is preferably spraye3d onto the particles in mixer 36. In one embodiment, the mixer 36 is preferably comprised of nozzles through which the slurry may be sprayed as the particles are being tumbled.

In another embodiment, instead of using a slurry, the particles are treated with a lubricating oil and/or an amine agent.

During the tumbling/spraying process, it is preferred to subject the particles being so treated to a temperature of at least 130 degrees Celsius. It is also preferred to conduct the spraying operation so that a substantially homogeneous mixture of coated particles is produced. In one embodiment, the spraying, tumbling, and heating operations occur simultaneously for a period of at least 15 minutes.

In one embodiment, the coating produced on the particles, after drying, is applied at a coating weight of form about 0.25 to about 0.4 weight percent, by weight of uncoated particles.

Referring to FIG. 1, after the coated particles are prepared in mixer 36, they are then fed via line 40 to mixer 38, wherein the amine agent and/or the oil may be added in the manner described elsewhere in this specification. Thereafter, the treated particles may be fed via line 44 to mass flow silo 46.

### Another Preferred Process for Making Headlap Granules

FIG. 4 is a partial schematic of a process 400 for preparing coated headlap particles. Supply tank 402 contains oil such as, e.g., the napthenic mineral oil described elsewhere in this specification. Supply tank 404 contains antistrip agent such as, e.g., the amine antistrip agent disclosed elsewhere in this specification.

The oil used in supply tank 402 preferably has a viscosity, under ambient conditions, of from about 70 to about 300 centipoise and, more preferably, from about 80 to about 120 centipoise.

The oil from tank 402 is pumped by pump 406 to mixing tank 412. The antistrip agent from tank 404 is pumped by pump 408 to mixing tank 412. The flow rates of these materials are adjusted so that the correct ratio of oil/antistrip agent is present in mixing tank 412. This ratio, in one embodiment, is from about 2.5 to about 3.5.

It is preferred to maintain a substantially homogeneous mixture of the oil and the antistrip agent in mixing tank 412.

In order to maintain the mixture in tank 412 at the desired properties, the mixture is preferably continuously stirred with mixer 414 and heated with immersion heater 416.

The heated mixture from mixing tank 412 may be fed to coating pump 420 and/or coating pump 422. Oil from oil tank 410 may be added to the mixture that is fed to coating pump 420 and/or coating pump 422. Alternatively, or additionally, oil from oil tank 410 may be fed from coating pump 422, and the mixture may then be fed through valves 424 and 426 to coating screw 438.

In the embodiment illustrated in FIG. 4, the heated mixture of oil and antistrip agent is fed through metering pump 428 and flowmeter assembly 430, and thereafter it is sprayed onto the coating screw 438 which is conveying particles of limestone from classifier 432. The limestone particles from classifier 432 are fed into airlock 434 and thence into the coating screw 438.

### The Moh's Hardness of the Coated Granules

In one embodiment, and referring again to the coated particles produced in mixer 36 of FIG. 1, the Moh's hardness of the coated particles is from about 2.5 to about 3.5 and is often from about 2.9 to about 3.1. It should be noted that calcite, which is the predominant component of limestone, is 3.0 on the Moh's scale.

### The Adhesion of the Coated Granules

Applicant has discovered that treatment of the headlap particles with either the organic additive (such as the hydrocarbon oil) alone and/or the amine additive(s) increases the adhesion of the coated particles as long as such additives are preferably sprayed onto the particles in the manner described hereinabove.

In one preferred embodiment, the adhesion of the coated granules is tested in accordance with ASTM Standard test 4977-03. It is to be understood that, when reference is made to “adhesion loss as determined by ASTM Standard test 4977-3,” it is to be understood that such term refers to the adhesion loss of a shingle made in accordance with the specified procedure that has been subjected to the specified rub test. This rub test procedure is described elsewhere in this specification.

Without wishing to be bound to any particular theory, applicant believes that the product made in accordance with his invention, involving spraying, will pass the rub test but that products not so made (wherein, e.g., the additive is mixed by conventional means but not sprayed) often will fail such test.

### Another Preferred Process of the Invention

In one preferred embodiment, the particles produced in the air separation step are sprayed with an aqueous based dye composition comprised of water and a pigment that, preferably, is a particulate mix of azo and phthalocyanine dyes. The material is preferably sprayed onto the particles by a high pressure nozzle applicator under ambient conditions, and then it is dried and cured.

In one aspect of this embodiment, about 1.0 weight percent of the pigment material, by weight of spray, is applied to the particles by running them through a screw conveyor while spray is applied to them; the particles are preferably tumbled through the screw conveyor while being sprayed, thereby insuring uniform mixing.

The sprayed particles are preferably passed through a heated flight screw conveyor that heats and dries them, utilizing temperatures in the range of from about 200 to about 300 degrees Fahrenheit.

### A Preferred Dye Material

In one preferred embodiment, the dye material used in the aforementioned process is the dye material described in U.S. Pat. No. 8,652,219, the entire disclosure of which is hereby incorporated by reference into this application.

Claim 1 of U.S. Pat. No. 8,652,219 discloses: “1. A process for providing a dye material consisting of a mixture of azo and phthalocyanine dyes suitable for making colored and sealed concrete surfaces, said process consisting essentially of the following steps: (a) packaging said mixture of azo and phthalocyanine dyes as a non-hazardous powdered solute in a fluid resistant container; (b) transporting said powdered solute to a work site; (c) on-site adding a portion of said powdered solute to a carrier containing an amount of at least one solvent including acetone; mixing said portion of said powdered solute with said amount of at least one solvent to create a dye composition; (e) adding butyl celloslove as a drying agent to said dye composition; and (f) applying said dye composition upon a concrete surface with an aerosol sprayer . . . . ”

During the prosecution of U.S. Pat. No. 8,652,219, U.S. Pat. Nos. 4,162,348, 5,476,722, 5,534,214, 6,388,002, and U.S. Pat. No. 6,443,996 were cited. The disclosure of each of these United States patents is hereby incorporated by reference into this specification. One or more of the dye materials described in these cited patents may also be used in the process of this invention.

During the prosecution of U.S. Pat. No. 8,652,219, published United States patent application 2001/0032567 was cited. The disclosure of this published United States patent application is hereby incorporated by reference into this specification. One or more of the dye materials described in such published United States patent application may also be used in the process of this invention.

Alternatively, or additionally, one may use one or more of the dye materials described in published United States patent application US 2014/0373287, the entire disclosure of which is hereby incorporated by reference into this specification.

### pH of the Granules

In one embodiment, the pH of the coated particles in mixer 44 and/or 45 is from about 8 to about 11 and, more preferably, from about 9 to about 11.

### Preparation of a Roofing Shingle

Referring again to FIG. 1, and in one preferred embodiment depicted therein, in step 56 roofing shingles are prepared with the coated granules disposed in mass flow silo 52.

The roofing shingles may be made in accordance with the procedure described in U.S. Pat. No. 3,888,684, the entire disclosure of which is hereby incorporated by reference into this specification; alternatively, such shingle may be made in accordance with the procedure described elsewhere in this specification.

As is disclosed in U.S. Pat. No. 3,884,684, “The asphaltic roofing compositions in which the novel algicidal roofing granules of the present invention are incorporated are roofing shingles, rolled roofing, and the like, having an organic asphalt-saturated felt base that is coated with an asphalt of a higher softening point and surfaced with base mineral granules having the subject inner and outer color coatings thereon. The felt layer is customarily composed of wood fibers, either alone or in combination with paper pulp, repulped paper and/or rags, asbestos fibers, or the like. Such felts are generally referred to in the industry as roofing felts. The saturants most commonly employed to saturate the felt layer include residual oil, soft residual asphalt and soft blown petroleum asphalt, and mixtures thereof. Preferred saturants generally have a ring and ball softening point of approximately 120° to 130° F. and a penetration of approximately 60 at 77° F.”

U.S. Pat. No. 3,888,684 also discloses that, “This saturated felt layer is then coated with an asphalt of a higher softening point and lower penetration from that of the saturant. Preferred materials will generally have a ring and ball softening point of approximately 175° to 260° F. and a penetration of approximately 10 to 50 at 77° F. Coating asphalts of this type include native and sludge asphalts, fatty acid pitches and the like. In accordance with customary practices in the art, this asphalt coating layer is commonly embedded with powdered or fibrous fillers of inorganic or organic origin, such as powdered silica (sand), limestone, slate dust, clay, etc., and mixtures thereof. Upon application of the asphalt coating to the saturated felt layer, the color coated roofing granules of the invention are applied to the asphalt layer surface, and the resulting roofing surface is then passed through suitable rollers and presses, quenched and otherwise treated and handled in accordance with conventional practice in the roofing industry.” (See from lines 27-63 of column 12.)

One may use the process disclosed in U.S. Pat. No. 4,274,243 to make the roofing shingle; the entire disclosure of this patent is hereby incorporated by reference into this specification. Claim 1 of this patent describes, “1. A method of forming a laminated roofing shingle comprising: (a) providing an indefinite length of asphalt-impregnated, felted material; (b) adhering a coating of mineral granules to at least one surface of said felted material; (c) cutting said material in a repeating pattern along the longitudinal dimension of said material so as to form an interleaved series of tabs of pairs of overlay members, each said tab, defined by said step of cutting, being of substantially identical shape and the lower edge of each said tab being defined by a smoothly curving negatively contoured edge; (d) making pairs of underlay members in a similar manner as above but wherein the lower edges of the underlay members are defined by a substantially continuously curving sinuous cut having a uniform periodic shape and amplitude such that each pair of underlay members thus formed are substantially identical; and (e) laminating said underlay members to said overlay members so as to form a series of shingles having substantially the same overall shape, wherein said step of laminating further includes the step of positioning said negatively contoured edge of each said tab directly over a substantially correspondingly curving portion of the lower edge of each said underlay member so as to simulate a series of alternating ridges and valleys of a portion of a tile covered roof.”

One may use one or more of the mats described in U.S. Pat. No. 4,634,622 to make the roofing shingle; the entire disclosure of such patent is hereby incorporated by reference into this specification. As is disclosed in such patent, “Asphalt shingles and roll roofing have been produced in the same general manner for many years. The industry initially used an organic fibrous mat or an asbestos fiber mat as the preformed carrier. Mats of this type contributed significantly to the strength and flexibility of the finished product. Normally they were saturated with unfilled asphalt for waterproofing purposes, then coated with a thickness of filled asphalt in which a layer of roofing granules subsequently was embedded. The asphalt layer acted as a further waterproofing layer and held the granules in place. The granules and the fillers in the asphalt layer also protected the asphalt against the deleterious action of ultraviolet rays.”

U.S. Pat. No. 4,634,622 also discloses that, “Later, the industry began moving more to the use of fiberglass mats instead of the conventional organic fibrous mats or asbestos fiber mats. Because fiberglass mats are much more porous than the previously used mats, this change eliminated the need for asphalt saturant. Instead, filled asphalt previously used only for the coating layer was now used both to impregnate and to coat the mat. Thus the properties of the filled asphalt became more critical. In addition to its waterproofing and weather resistant characteristics, the filled asphalt had to contribute more to the strength of the product, providing stability against deformation at roof temperatures and withstanding stresses encountered in the manufacturing process. Also, it had to adequately resist stresses due to handling by workmen and encountered by environmental conditions such as wind loading and thermal stresses.”

U.S. Pat. No. 4,634,622 also discloses that, “The filler which has been used by the industry is mineral in nature comprised, for example, of ground limestone, silica, slate, trap rock fines, and the like, and is present in the asphalt in substantial amounts. Typically, the filler used in these conventional roofing products has a specific gravity of between about 2.5 and about 3, which is several times more dense than the asphalt which it extends or displaces (the specific gravity of asphalt is about 1.0). Thus a filler content of about 60% by weight yields a filled asphalt having a specific gravity of about 1.7.”

One may use the process described in United States patent U.S. Pat. No. 5,411,803 to make the roofing shingle. As is disclosed in such patent, “Bituminous sheet materials such as roofing shingles may be produced using the granules of the invention. Roofing shingles typically comprise materials such as felt, fiberglass, and the like. Application of a saturant or impregnant such as asphalt is essential to entirely permeate the felt or fiberglass base. Typically, applied over the impregnated base is a waterproof or water-resistant coating, such as asphaltum, upon which is then applied a surfacing of mineral granules, which completes the conventional roofing shingle.” (See column 9, lines 47-57.)

Asphalt is preferably used to making the roofing shingles. As is disclosed on page 71 of George S. Brady et al.'s “Materials Handbook,” Twelfth Edition (McGraw-Hill Book Company, New York, N.Y., 1986), asphalt is “A bituminous, brownish to jet-black substance, solid or semi-solid, found in various parts of the world. It consists of a mixture of hydrocarbons, is fusible and largely soluble in carbon disulfide. It is also soluble in petroleum solvents and turpentine. The melting points range from 32 to 38 degrees C. Large deposits occur in Trinidad and Venezuela. Asphalt is of animal origin, as distinct from coals of vegetable origin. Native asphalt usually contains much mineral matter; and crude Trinidad asphalt has a composition of about 47% bitumen, 28 clay, and 25 water. Artificial asphalt is a term applied to the bituminous residue from coal distillation mechanically mixed with sand or limestone.”

Asphalt is also described in the claims of various United States patents, such as, e.g., U.S. Pat. No. 3,617,329 (liquid asphalt), U.S. Pat. No. 4,328,147 (roofing asphalt formulation), U.S. Pat. No. 4,382,989 (roofing asphalt formulation), U.S. Pat. No. 4,634,622 (lightweight asphalt based building materials), U.S. Pat. No. 4,895,754 (oil treated mineral filler for asphalt), U.S. Pat. No. 5,217,530 (asphalt pavements), U.S. Pat. No. 5,356,664 (method of inhibiting algae growth on asphalt shingles), U.S. Pat. No. 5,380,552 (method of improving adhesion between roofing granules and asphalt-based roofing materials), U.S. Pat. No. 5,382,449 (method of using volcanic ash to maintain separation between asphalt roofing shingles), U.S. Pat. No. 5,511,899 (recycled waste asphalt), U.S. Pat. No. 5,516,573 (roofing materials having a thermoplastic adhesive interface between coating asphalt and roofing granules), U.S. Pat. No. 5,746,830 (pneumatic granule blender for asphalt shingles), U.S. Pat. No. 5,776,541 (method and apparatus for forming an irregular pattern of granules on an asphalt coated sheet), U.S. Pat. No. 5,795,622 (method of rotating or oscillating a flow of granules to form a pattern on an asphalt coated sheet), U.S. Pat. No. 6,095,082 (apparatus for applying granules to an asphalt coated sheet to form a pattern having inner and outer portions), U.S. Pat. No. 6,358,319 (vacuum treatment of asphalt coating), U.S. Pat. No. 6,358,319 (magnetic method and apparatus for depositing granules onto an asphalt-coated sheet), U.S. Pat. No. 6,465,058 (magnetic method for depositing granules onto an asphalt-coated sheet), and the like. The entire disclosure of each of these United States patents is hereby incorporated by reference into this specification.

In the process of making a shingle, asphalt is preferably deposited onto a fibrous mat such as, e.g., a fiberglass mat. One may use, e.g., any of the fiberglass mats described in the prior art. Thus, e.g., one may use the fiberglass mat described in U.S. Pat. No. 7,678,467, the entire disclosure of which is hereby incorporated by reference into this specification. Claim 1 of this patent describes: “1. An asphalt shingle comprising: an organic felt or fiberglass mat; a first layer of a chemically-modified, air-blown asphalt and a second layer of a chemically-modified, air-blown asphalt, wherein the mat is coated on its top surface by one of the layers of chemically-modified, air-blown asphalt and the mat is coated on its bottom surface by the other layer of chemically-modified air-blown asphalt; and a surfacing material embedded into the surface, that is opposed to the mat, of at least one of the chemically-modified air-blown asphalt layers; wherein said chemically-modified, air-blown asphalt is formed by a process for modifying an asphalt that comprising air blowing the asphalt and mixing polyphosphoric acid with the asphalt before the air blowing, during the air blowing, or a combination thereof to form the chemically-modified, air-blown asphalt.

By way of further illustration, one may use the glass fiber mat disclosed in U.S. Pat. No. 6,993,876 (glass fiber mat comprised of an adhesion promoter and an organic resin binder), U.S. Pat. No. 6,817,152 (non-woven glass fiber mat comprised of polysiloxane), U.S. Pat. No. 6,706,147 (non-woven fiber mat comprised of a cured polysiloxane), U.S. Pat. No. 6,562,118 (cellulosic fiber mat), U.S. Pat. No. 5,865,003 (glass fiber mat comprised of portions with different binder concentrations), U.S. Pat. No. 5,851,933 (glass fiber mat treated with a modified urea formaldehyde resin), and the like. The entire disclosure of each of these United States patents is hereby incorporated by reference into this specification.

Referring again to FIG. 1, the particles conveyed to mass flow silo 46 are suitable for use as headlap granules. Additionally, because of their low translucency and their optical properties, they may also be used as prime granules. As is known to those skilled in the art, “Often, in the manufacture of shingles, at least two types of granules are employed: 1) headlap granules which are granules of relatively low cost for portions of the shingle which are to be covered up; and 2) prime granules which are granules of relatively higher cost and are applied to the portions of the shingle which will be exposed on the roof. It is to be understood that the term “prime” granules generally includes both highlighted colored blend drop granules and background granules.” This quote is taken from published United States patent application US2007/0082126, the entire disclosure of which is hereby incorporated by reference into this specification.

In one embodiment, the coated particles of this invention are comprised of a multiplicity of crystallites that, when contacted with daylight, produce electromagnetic energy that is lethal to algae. In one aspect of this embodiment, such crystallites are comprised or consist essentially of inorganic material.

### A Preferred Asphalt Shingle

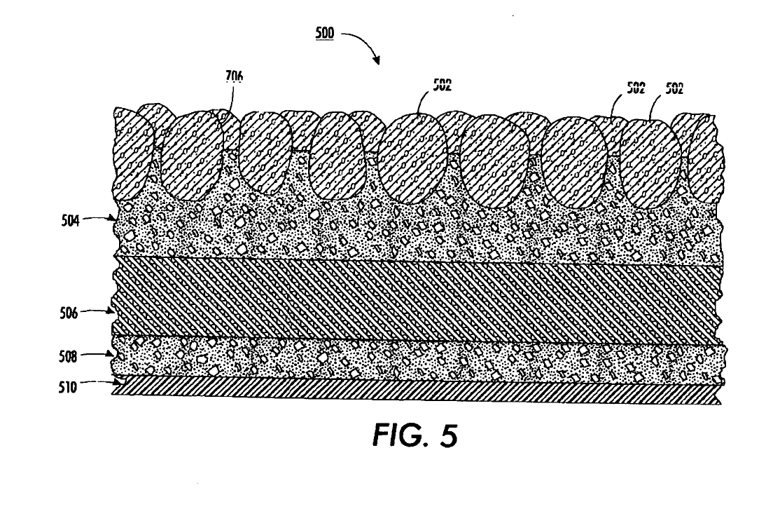

FIG. 5 is a schematic diagram of an asphalt shingle 500 made in accordance with the procedure described elsewhere in this specification. The headlap particles 502 made in accordance with the process of this invention are disposed within an asphalt material 504 that, in one embodiment is a stabilized asphalt.

Referring to FIG. 5, it will be seen that the headlap particles 502 are preferably not spherical, i.e., their aspect ratios (the ratio of the largest axis of the particle to the smallest axis) is greater than 1.0. In general, the aspect ratio of the headlap particles is from about 1.4 to about 2.0.

Referring again to FIG. 5, it will be seen that, in the embodiment depicted, the headlap particles are not homogeneous, i.e., different of the particles 502 have different sizes and/or shapes. Furthermore, different of the particles 502 are disposed within the asphalt 504 to different depths.

In the embodiment depicted in FIG. 5, the asphalt 504 is disposed over a Fiberglass base 506 that is contiguous with both the top layer of asphalt 504 and the bottom layer of asphalt 508. A bottom backsurfacing layer 510 is contiguous with the bottom layer of asphalt 508.

Means for Generating an Algicide and/or a Bactericide In Situ

In one preferred embodiment, the mineral composition of the present invention is comprised of means for producing an algicide or a bactericide after being exposed to electromagnetic radiation. Such means are well known to those skilled in the art.

Such means may exit a “photodynamic action,” i.e., upon irradiation with light they act as catalysts for the oxidation of various substrates with oxygen. Some of these “photodynamic catalysts” are discussed in column 1 of U.S. Pat. No. 4,530,924, the entire disclosure of which is hereby incorporated by reference into this specification. In the third full paragraph of such column 1, it is disclosed that: “It is known that certain dyes, for example eosin, Bengal Rose, methylene blue and others, have a so-called photodynamic action, i.e. on irradiation with light, they act as catalysts for the oxidation of various substrates with oxygen [see, for example, G. O. Schenck, Angew. Chem. 69, 579 (1957)]. Because of this property, the said dyes also have a certain antimicrobial action [see, for example, Venkataraman, The Chemistry of Synthetic Dyes, Volume 4 (1971) pages 502-505 and C. J. Wallis, J. L. Melnick, J. Bacteriol. 89, 41 (1965)].” As is disclosed in column 6 of such patent, the phthalocyanine compounds of this patent develop antimicrobial activity upon being irradiated by visible and/or infrared light. The wavelength of visible light is from about 400 to about 750 nanometers. Infrared radiation is the invisible portion of the electromagnetic spectrum that lies between about 0.75 and 1,000 microns; radiation in the near infrared (from about 0.75 to about 3 microns) produces a sensation of heat.

Such means may be a photocatalyst, as that term is defined in U.S. Pat. No. 5,541,096, the entire disclosure of which is hereby incorporated by reference into this specification. This patent discloses that algae, fungi, and bacteria may be killed when titanium oxy compounds (such as titanium oxides) are exposed to electromagnetic radiation. These titanium oxy compounds (and others) are discussed at column 4 of the patent, wherein it is disclosed that: “Photosemiconductor particles having photocatalytic function include known photocatalysts such as titanium oxy compounds, zinc oxide, tungsten oxide, iron oxide, strontium titanate, molybdenum sulfide, cadmium sulfide, and the like, which can be used alone or in combination of two or more. Particularly, preferred are titanium oxy compounds having a higher photocatalytic function, higher chemical stability and being harmless. As used in the present invention, the term ‘titanium oxy compounds’ refers to those so-called titanium oxide, hydrated titanium oxide, hydrous titanium oxide, metatitanic acid, orthotitanic acid, titanium hydroxide and the like, the crystal form of which is not critical. The titanium oxy compounds as above may be produced by any one of a variety of known methods . . . ”

By way of further illustration, one may use the photocatalytic hydrophilic coating compositions disclosed in U.S. Pat. No. 5,916,947, the entire disclosure of which is hereby incorporated by reference into this specification. This patent discloses that, when exposed to visible light, “aqueous aerated solutions containing zinc oxide pigment leads to the formation of hydrogen peroxide only when exposed to ultraviolet light of wavelengths greater than 400 nm . . . ” (see columns 1-2). By comparison, when exposed to “visible light” (i.e., electromagnetic radiation detectable by the eye, ranging in wavelength from about 400 to about 740 nanometers), the zinc oxide composition of this patent become toxic to life. This composition is described, e.g., in claim 1 of such patent, which describes: “1. A material useful for producing antifouling activity when incorporated into a carrier comprising: about between 20 wt. % and 60 wt. % of the total material weight of zinc oxide containing less than about 0.001% by weight of lead, cadmium and sulphur oxides and being obtained from colloidal zinc oxide so as to have a mean particle size of between 0.1 to 0.5 microns and a surface area between 1 to 10 square meters per gram; a photosensitizer in photoelectric contact with zinc oxide and being present in a ratio of one part by weight or less of photosensitizer to four parts by weight zinc oxide, said photosensitizer having a solubility below five parts per million by weight in water and wherein said photosensitizer is surface coated onto said zinc oxide and is selected from the group consisting of fumed anatase, strontium titanate, bianthrone, azulene, zinc pyrithione, terthiophene, hypericin and mixtures thereof.”

In one embodiment, the toxic agent precursor used in the mineral composition of this invention produces a toxic agent when subjected to electromagnetic radiation. As used herein, the term electromagnetic radiation refers to radiation emitted from vibrating charged particles. As is known to those skilled in the art, a combination of oscillating electrical and magnetic fields propagates through otherwise empty space with the velocity of light; the constant velocity equals the alternation frequency multiplied by the wavelength. Reference may be had, e.g., to U.S. Pat. No. 5,374,405 (rotating fluidized bed reactor with electromagnetic radiation source), U.S. Pat. No. 5,686,178 (metal coated substrate articles responsive to electromagnetic radiation), U.S. Pat. No. 6,183,727 (use of long wavelength electromagnetic radiation), U.S. Pat. No. 6,369,399 (electromagnetic radiation shielding material and device), U.S. Pat. No. 6,616,451 (electromagnetic radiation emitting toothbrush), U.S. Pat. No. 6,654,627 (method and device for recording polarized electromagnetic radiation of inactivated strain of pathogenic microorganisms), and the like. The entire disclosure of each of these United States patents is hereby incorporated by reference into this specification.

One may use the titanium oxide toxic agent precursor disclosed in U.S. Pat. No. 6,291,067, the entire disclosure of which is hereby incorporated by reference into this specification. In column 1 of such patent, it is disclosed that: “When titanium oxide is irradiated with light, an electron having a strong reducing action and a positive hole having a strong oxidizing action are generated and a molecular seed coming into contact therewith is decomposed by the oxidation-reduction action. Using such an action, namely, photocatalytic action of titanium oxide, organic solvents dissolved in water, environmental pollutants such as agricultural chemicals and surface active agents, or harmful substances in air or malodors can be decomposition-removed. This method utilizes only titanium oxide and light and can be repeatedly used, and moreover, the resulting reaction product is a harmless carbon dioxide or the like.” Claim 1 of this patent describes: “1. An organic polymer fiber having an environmental clarification function, which has supported thereon a photocatalytic powder for environmental clarification, said powder comprising finely divided titanium dioxide particles having a coating of porous calcium phosphate formed on at least part of the surface of each finely divided titanium dioxide particle, wherein an anionic surface active agent is present at least on the interface between said coating of porous calcium phosphate and the finely divided titanium dioxide particle.” In the experiments described in the Examples of such patent, and ultraviolet light source (i.e., a source of electromagnetic radiation with a wavelength of from about 1 to about 400 nanometers) was used.

One may use one of the “oxygen molecule absorbing/desorbing” agents disclosed in U.S. Pat. No. 6,294,247, the entire disclosure of which is hereby incorporated by reference into this specification. As is disclosed in column 1 of this patent, “TiO₂, V₂O₅, ZnO, WO₃, etc. have heretofore been known as substances which, when irradiated by ultraviolet radiation, cause oxygen molecules to be adsorbed to or desorbed from an organic compound such as a smelly constituent for promoting decomposition (oxidation) of the organic compound . . . . For photocatalytic particles such as TiO₂ particles to function effectively as a photocatalyst, it is necessary that the photocatalytic particles be irradiated with ultraviolet radiation and held in contact with a substance to be decomposed thereby such as a smelly gas or the like.”

One may use a titanium dioxide photocatalyst having a monoclinic crystal structure that is disclosed in U.S. Pat. No. 6,306,796, the entire disclosure of which is hereby incorporated by reference into this specification. Claim 1 of this patent describes: “1. A titanium dioxide photocatalyst having a monoclinic crystal structure; wherein said photocatalyst is irradiated with light of a wave length which has energy greater than a band gap of the photocatalyst.” The materials that are degraded by the photocatalyst of this paten are described in column 2 of the patent and include: “Examples of deleterious materials which are decomposed or oxidized by photocatalytic reaction by use of titanium oxide and then removed, are materials having adverse effect upon human body and living environment, and materials which might have such adverse effect. For instance, there are a variety of biochemical oxygen demand materials; environmental pollution materials such as air pollution materials; materials of various agricultural chemicals such as herbicide, bactericide, insecticide and nematocide; and microorganism such as bacteria, actinomyces, funguses, algaes and molds. Examples of environmental pollution materials are organic halogen compounds, organic phosphorus compounds, other organic compounds, and inorganic compounds such as nitrogen compounds, sulfur compounds, cyanide and chromium compounds. Examples of organic halogen compounds are polychlorinated biphenyl, fleon, trihalomethanes, trichloroethylene, and tetrachloroethylene. Examples of organic compounds other than organic halogen compounds and organic phosphorous compounds are surface active agents, hydrocarbons such as oils, aldehydes, mercaptans, alcohols, amines, amino acid, and protein. Examples of nitrogen compounds are ammonia and nitrogen oxide.”

One may use a crystalline toxic agent precursor such as, e.g., the crystalline titania disclosed in U.S. Pat. No. 6,362,121, the entire disclosure of which is hereby incorporated by reference into this specification. Claim 1 of such patent describes: “1. A substrate provided, on at least a portion of one of its faces, with a coating with a photocatalytic property based on titanium dioxide which exhibits an external hydrophilic surface, which is at least partially crystalline and which is incorporated in said coating partly in the form of particles predominantly crystallized in the anatase form, said particles being incorporated in the coating using an inorganic binder in the form of an amorphous or partially crystalline silicon oxide or a mixture of oxides comprising silicon oxides.”

One may use one or more of the photocatalysts described in U.S. Pat. No. 6,368,668, the entire disclosure of which is hereby incorporated by reference into this specification. A process for producing at least some of these photocatalysts is described in claim 1 of such patent, which discloses: “1. A process for producing a functional material having photocatalytic activity, comprising the steps of: coating a photocatalyst coating composition comprising a photocatalytic metal oxide and/or a precursor of the photocatalytic metal oxide onto the surface of a substrate; and rapidly heating the surface of the coated substrate to fix the photocatalytic metal oxide onto the surface of the substrate, characterized in that: the rapid heating is carried out by a heating means provided with a heating element having a heating value per unit area of not less than 120 MJ/m2 hr, and the distance between the heating element and the surface of the substrate is 5 to 300 mm, and the rapid heating is carried out for 2 to 60 seconds.”

One may use the ultrafine titanium dioxide powder disclosed in U.S. Pat. No. 6,383,980 to produce an algicidal agent; the entire disclosure of this patent is hereby incorporated by reference into this specification. This material is described in claim 1 of such patent, and it discloses: “1. A photocatalytic titanium dioxide powder comprising finely divided titanium dioxide particles each having supported on the surface thereof a first supported layer comprising a calcium compound, and further having supported on the surface of said first supported layer-formed titanium dioxide particle a porous second supported layer comprising a photocatalytically inactive and substantially water-insoluble substance.”

One may use the pyrrole photosensitizer disclosed in U.S. Pat. No. 6,454,951, the entire disclosure of which is hereby incorporated by reference into this specification. Claim 1 of this patent describes: “1. A composition comprising a solid carrier and more than one photosensitizer comprising a tetrapyrrole and/or tetraazapyrrole compound, wherein the carrier is swellable in water and is selected from the group consisting of polystyrol, sephadex and clay, and wherein the more than one photosensitizer are chemically bonded to the carrier, have different absorption maxima, and are selected such that the entire spectrum of visible light is utilized for photosensitization.” As is disclosed in columns 1 and 2 of such patent, such photosensitizer can be used to kill algae, yeast, fungi, germs, etc. As is disclosed in such column 1, “the terms, ‘germs and/or microorganisms’ relate to microbes, especially microbes which can be pathogeneous, as e.g. gram-positive, gram-negative bacteria, algae, yeast and fungi, wherein said germs can be present alone or in combination with other microorganisms.”

One may utilize the photocatalytic composition disclosed in U.S. Pat. No. 6,683,023, the entire disclosure of which is hereby incorporated by reference into this specification. In column 1 of this patent, it is disclosed that many of the prior art algicides and bactericides in addition to killing pathogens, also attacks the organic material in which it is disposed. It is disclosed in such column 1 that: “In recent years, photocatalytic fine particles using titanium dioxide are attracting attention as an environmental cleaning material for antimicrobial, deodorization, antifouling, air cleaning, water cleaning and the like. The photocatalytic mechanism of titanium dioxide is considered attributable to the following mechanism. Upon irradiation of light on a titanium dioxide fine particle, an electron and a hole are generated inside the titanium dioxide fine particle, which reacts with water or oxygen in the vicinity of the surface of a titanium dioxide fine particle to generate hydroxy radical or hydrogen peroxide. As a result, strong oxidation reduction activity of this hydroxy radical or hydrogen peroxide, harmful organic substances are decomposed into carbon dioxide and water, and thereby cleaned. Such photocatalytic activity of a titanium dioxide fine particle is thought to semipermanently continue as long as a titanium dioxide fine particle, light, water and oxygen are present.”

U.S. Pat. No. 6,683,023 also discloses that: “By taking advantage of this photocatalytic property of titanium dioxide, as a representative application example, titanium dioxide fine particles are being kneaded into an easily handleable medium, such as fiber or a plastic molded article, or into a coating on the surface of a substrate, such as cloth or paper. However, decomposition or deterioration by the strong photocatalytic activity of titanium dioxide readily occurs not only on harmful organic materials or environmental pollutants but also on the medium itself such as fiber, plastic or paper and this is an obstacle to durability in practical use. Due to easy handleability of the titanium dioxide fine particle, a coating material comprising a mixture of titanium dioxide fine particles and a binder has been developed. However, an inexpensive binder having durability sufficiently high to overcome, for example, decomposition or deterioration on the medium has not yet been found.”

U.S. Pat. No. 6,683,023 also discloses that: “JP-A-9-225319 (the term “JP-A” as used herein means an “unexamined published Japanese patent application”) and JP-A-9-239277 disclose means for preventing and suppressing the deterioration of a resin medium or the deterioration of a binder due to the strong photocatalytic activity of titanium dioxide particles. The proposed means is a method of allowing a photo-inactive compound having such as aluminum, silicon and zirconium to be supported on a titanium dioxide particle in an archipelago shape having a steric barrier to retard the photocatalytic activity. According to this method, the photo-inactive compound is supported in an archipelago shape; however, specific sites of the resin medium or the binder disadvantageously remain present under the strong photocatalytic activity of titanium dioxide.”

U.S. Pat. No. 6,683,023 also discloses that: “International Publication WO99/33566 discloses a powder material of titanium dioxide fine particles, where a porous coating layer of calcium phosphate is formed on at least a part of the surface of a titanium dioxide fine particle and an anionic surfactant is present at the interface therebetween.”

U.S. Pat. No. 6,683,023 also discloses that: “With respect to a slurry containing titanium dioxide having photocatalytic activity, JP-A-10-142008 discloses an anatase-type titanium oxide-containing slurry which is obtained by heat-treating a titania sol, a titania gel form or a titania sol-gel mixture in a closed vessel simultaneously with a pressurization treatment and then dispersing using an ultrasonic wave or stirring the treated product.”

U.S. Pat. No. 6,683,023 also discloses that: “JP-A-11-343426 discloses a photocatalytic coating material having excellent dispersion stability and specifically discloses a photocatalytic coating material containing, in a solvent, a silica sol and titanium oxide having a Raman spectrum peak in the range of 146 to 150 cm-1 and being occupied by anatase type titanium dioxide in a ratio of 95% by mass or more.”

One may coat the mineral composition of this invention with a photocatalytic coating such as, e.g., the coating described in claim 1 of U.S. Pat. No. 6,700,066, the entire disclosure of which is hereby incorporated by reference into this specification. Claim 1 of this patent describes: “1. A coated substrate prepared by a process comprising: (a) preparing a substrate for deposition with a coating, wherein the coating comprises crystallized particles of an oxide of a metal A having photocatalytic properties, a mineral binder comprising at least one oxide of a metal B having photocatalytic properties, optionally at least one oxide of a metal M devoid of photocatalytic properties, and optionally at least one silicon oxide; (b) depositing the coating onto a surface of the substrate, by depositing the coating from liquid-phase dispersions containing oxides of the metals A and B, optionally the oxide of metal M and optionally the silicon oxide, in a relative proportion by weight of the metals and Si given by A/(B+M+Si), the relative proportion ranging from 60/40 to 40/60; and (c) allowing the coating to set.”

The coatings of U.S. Pat. No. 6,720,066 provide both photocatalytic performance and durability. As is disclosed in column 2 of such patent, “The present invention has allowed the simultaneous optimization of two coating properties, photocatalytic performance and coating durability, which previously appeared to be incompatible.”

One may use a photocatalytic material having titanium oxide crystals and anions X incorporated therein, as is disclosed in U.S. Pat. No. 6,794,065, the entire disclosure of which is hereby incorporated by reference into this specification. Claim 1 of this patent discloses: “1. A photocatalytic material exhibiting a photocatalytic action when exposed to light with a wavelength in the region of ultraviolet light and visible light, comprising a titanium compound Ti—O—X obtained by at least one of: substituting an anion X for a plurality of oxygen sites of titanium oxide crystals, doping an anion X between lattices of a titanium oxide crystal, and doping an anion X in grain boundaries of titanium oxide aggregate.” In column 1 of this patent, a discussion is presented as to why most titania materials exhibit photocatalytic activity only in the ultraviolet range. It is disclosed that: “Hitherto, known materials exhibiting a photocatalytic action include the likes of TiO2 (titanium dioxide), CdS (cadmium sulfide), WO3 (tungsten trioxide), and ZnO (zinc oxide). These photocatalytic materials are semiconductors, absorb light to form electrons and holes, and present various chemical reactions and bactericidal actions. However, because titanium oxide is nontoxic and is superior from the standpoint of stability to water and acid, so far only titanium oxide has been put to practical commercial use as a photocatalyst.”

U.S. Pat. No. 6,794,065 also discloses that: “However, because of the values of the band gap (Eg=3.2 eV) of titanium oxide, the operating light of such a titanium oxide photocatalyst is limited to ultraviolet light with a wavelength .lambda.<380 nm. As a consequence, there remains an unfulfilled demand for development of materials which exhibit catalytic activity when irradiated with visible light with a wavelength of 380 nm or longer. These materials are desired, for example, for use indoors and for improving photocatalytic activity.”

U.S. Pat. No. 6,794,065 also discloses that: “As described in Japanese Patent Laid-Open publication No. Hei 9-262482, by modifying materials using ion implanting of metal elements such as Cr (chrome) and V (vanadium) in anatase type titanium oxide having a high catalytic activity, the light absorbing edge of titanium oxide can be shifted to the long wavelength side to permit the operation of titanium oxide catalyst in visible light. No reports discussing the doping of Cr, V, and so on have been published since the early 1970s which succeeded in operating under visible light. Japanese Patent Laid-Open publication No. Hei 9-262482 describes that operation under visible light can be enabled through use of special techniques for doping Cr, V, and so on. Thus, in the above conventional example, the operation of TiO2 photocatalyst under visible light is made possible by a technique of ion implanting metal elements in TiO2. However, metal ion implantation is disadvantageous because of its high cost. While there is a demand for methods for manufacturing TiO2 photocatalyst, such as by synthesis in solution or by sputtering, when these methods are employed, the resulting photocatalysts can not be operated under visible light. It is generally considered that this is because Cr of the dopant aggregates or forms oxides such as Cr2 O3 in a crystallization process. Thus, in the conventional examples, there is a problem that a technique of ion implanting metal elements must be adopted in order for metal elements to be used to enable operation of TiO2 under visible light.”

One may use a photocatalytic material that is activated by visible light such as, e.g., the material disclosed in U.S. Pat. No. 6,835,688, the entire disclosure of which is hereby incorporated by reference into this specification. As is disclosed in column 1 of this patent, “Conventionally known materials exhibiting a photocatalytic action include TiO2 (titanium dioxide), CdS (cadmium sulfide), WO3 (tungsten trioxide), and ZnO (zinc oxide), for example. These photocatalytic materials are semiconductors, absorb light to form electrons and holes, and also promote various chemical reactions and bactericidal actions. However, because titanium oxide is nontoxic and exhibits a superior stability to water and acid, thus far, only titanium oxide has afforded practical commercial use as a photocatalyst. However, because of the values of the band gap (Eg=3.2 eV) of titanium oxide the operating light of such a titanium oxide photocatalyst is limited to ultraviolet light with a wavelength.lambda.<380 nm. As a consequence, an unfulfilled demand exits for materials which exhibit catalytic activity when irradiated with visible light having a wavelength of 380 nm or longer. These materials are desired, for example, for use indoors and for improving photocatalytic activity.”

U.S. Pat. No. 6,835,688 also discloses that: ‘As described in Japanese Patent Laid-Open publication No. Hei 9-262482, by modifying materials using ion implanting of metal elements such as Cr (chromium) and V (vanadium) in anatase type titanium oxide having a high catalytic activity, the light absorbing edge of titanium oxide can be shifted to the long wavelength side to permit the operation of titanium oxide catalyst in visible light. Although a number of reports discussing the doping of Cr, and V, for example, on have been published since the early 1970s, these reports describe, however, that in instances where operation under visible light is enabled, the performance of the titanium oxide sharply lowers. On the other hand, as described in Japanese Patent Laid-Open publication No. Hei 9-262482, the original performance of titanium oxide can be maintained through use of special techniques for doping Cr, and V, for example. Thus, in the above conventional example, the operation of titanium oxide photocatalyst under visible light is made possible by ion implantation of metal elements in titanium oxide.’

### A Preferred Filler for Making Filled Asphalt Compositions

In one preferred embodiment, the filler used to make the filled asphalt compositions is the same or substantially the same as the filler disclosed and claimed in U.S. Pat. No. 7,833,339, the entire disclosure of which is hereby incorporated by reference into this specification.

Claim 1 of U.S. Pat. No. 7,833,339 describes: “1. A composition comprised of asphalt and filler, wherein said filler is comprised of particles that comprise an inorganic core and a coating disposed on said core, wherein at least about 60 weight percent of said particles are smaller than about 212 microns, and wherein: (a) at least 95 weight percent of said particles are comprised of particles of calcium carbonate; (b) said composition, at a temperature of from about 425 to about 475 degrees Fahrenheit, has a viscosity of from about 2000 to about 45000 centipoise; (c) said asphalt has a flash point of less than 540 degrees Fahrenheit; (d) said coating is comprised of an amine anti-strip agent; (e) said particles of calcium carbonate . . . are smaller than 100 microns; (f) said particles of calcium carbonate are larger than 150 microns; (g) at least 80 weight percent of said particles of calcium carbonate that are smaller than 100 microns are coated with said coating comprised of said amine anti-strip agent; and (h) less than 10 weight percent of said particles of calcium carbonate that are larger than 150 microns are coated with said coating comprised of said amine anti-strip agent.”

In one embodiment, a filler similar to the filler described in such claim 1 of U.S. Pat. No. 7,833,339 is used, but it is not coated with the amine anti-strip agent. In one aspect of this embodiment, the filler material is uncoated. In another aspect of this embodiment, the filler material is coated with a hydrocarbon oil. In yet another aspect of this embodiment, the filler contains from about 40 to about 95 weight percent of calcium carbonate and may be, e.g., a dolomitic limestone material.

### Another Process of the Invention Using a Dye Material

In one preferred process, a dye material is used to coat the particles produced in the air separation step described elsewhere in this specification. In one embodiment, these particles, before being coated, contain less than 1.0 percent of particles smaller than 250 microns, contain less than 1.0 percent of particles greater than 2380 microns, contain from about 2 to about 10 percent of particles greater than 1,680 microns, and contain less than 2 percent of particles less than 40 microns.

These particles may be coated in substantially the same manner that the particles used in other processes of the invention (where the particles, e.g., are coated with naphthenic mineral oil) are coated.

Thus, e.g., the particles to be coated should contain less than about 0.2 percent of moisture. This is often achieved when the particles are dried prior to screening by heating them to a temperature of from about 250 to about 300 degrees Fahrenheit.

Thus, e.g., the particles to be coated preferably contain less than 1.0 percent of particles smaller than 60 mesh (250 microns).

Thus, e.g., the particles to be coated are preferably sprayed with a high pressure nozzle applicator under ambient conditions. In one aspect of this embodiment, the particles are tumbled as they are being sprayed to insure uniform application. Thus, e.g., the particles may be run through a screw conveyor as they are being sprayed to tumble them and to insure uniformity.

In one preferred embodiment, about 1.0 weight percent of the dye composition, by wet weight of spray, is applied to the particles, by dry weight of particles.

After the particles have been sprayed, they are then dried to drive of water and enhance bonding between the particles and the sprayed on material. In one embodiment, the particles may be passed through a screw conveyor with heated flights in order to heat them to a temperature of from about 200 to about 300 degrees Fahrenheit.

In one embodiment, the material applied to the particles is organic. As is used herein, the term organic refers to a compound or composition that contains carbon.

In one embodiment, the material applied to the particles contains one or more nitrogen atoms. Thus, e.g., azo dyes may be used, either separately or in combination with other materials; thus, phthalocyanine dyes may also be used; as is known to those in the art, both of these materials contain both carbon nitrogen atoms.

In one preferred embodiment, the treated particles are “colorfast,” that is, when they are heated in boiling water, they do not lose a noticeable amount of their color. In one test, 100 grams of treated particles are heated in 300 milliliters of boiling water.

One preferred powdered dye material that may be used in a preferred process of this invention is disclosed at page 2 of published United States patent application US 2024/0373287. As is disclosed in paragraph[0022] of such published patent application, “Powder dye material 100 . . . is composed of a dry particulate mixture of azo and phthalocyanine dyes. It is expected that the ratio of azo and phthalocyanine dyes in the dry particles 101 of the dye material 100 can be altered to create different colors. For example, in a preferred embodiment, a deep green dye can be achieved by mixing yellow azo and red azo dye and blue phthalocyanine dye . . . ”

In paragraph[0031] of said published patent application, it is disclosed that “Additional chemicals 505, such as a drying agent like butyl cellosove, can be added 1505 to the dye composition 1000 for some surface applications, such as for sealed concrete. These additional chemicals 505 can be used to create a variety of effects, such as a mottled. In an embodiment having additional chemicals, the amount of aqueous material 500 added to the dye material 100 is decreased by half and the additional chemicals are added in an amount equal to the amount of aqueous material.

U.S. Pat. No. 8,652,219, the entire disclosure of which is hereby incorporated by reference into this specification, also discloses dye materials that may be used in the process of this invention. In column 3 of this patent, at lines 32 to 42, it is disclosed that: “Powder dye material 100 . . . is composed of a dry particulate 101 mixture of azo and phthalocyanine dyes. It is expected that the ratio of azo and phthalocyanine dyes in the dry particles 101 of the dye material 100 can be altered to create differing colors. For example, in a preferred embodiment, a deep green dye can be achieved by mixing yellow azo dye, red azo dye, and blue phthalocyanine dye. Specifically, for a five pound mixture 101 of deep green dye material 101 can be achieved by combining 945 grams of yellow azo dye, 378 grams of red azo dye, and 945 grams of blue phthalocyanine dye.

In one preferred process of the invention, the particles provided are comprised of an inorganic core bonded to an organic material. In one preferred aspect of this embodiment, the inorganic core is comprised of limestone, preferably limestone that contains at least 40 weight percent of calcium carbonate.

In one embodiment, the inorganic core is comprised of limestone that contains at least 85 weight percent of calcium carbonate and, more preferably, at least about 90 weight percent of calcium carbonate.

In another preferred embodiment, the inorganic core is comprised of dolomitic limestone. In one aspect of this embodiment, in addition to containing at least 40 weight percent of calcium carbonate, the limestone also contains from about 5 to about 40 weight percent of magnesium carbonate.

In addition to using carbonate minerals, one may use other minerals as the core material including, without limitation, slate, granite, silica, nephylene syenite, and the like.

It is preferred that the particles of core material, after being treated with the organic material, have a Moh's hardness of from about 3 to 9 and, more preferably, from about 4 to about 8.

In one embodiment, the particles of core material, after being treated with the organic material, are resistant to degradation by ultraviolet light.

In one embodiment, the particles of core material, after being treated with the organic material, are resistant to attack by biological entities such as mold, mildew, algae, fungi, bacteria, and the like.

In one embodiment, the particles of core material, after being treated with the organic material, and water impermeable.

In one embodiment, the particles of core material, after being treated with the organic material, have a Hardgrove Grindability index of less than about 70, and preferably less than about 60. In one embodiment, the Hardgrove Grindability of the treated particles is less than about 50.

In one embodiment, surface formed by the interaction between the inorganic core material and the organic material provide a barrier that not only prevents entry of water and gas (and other materials) into the core but also prevents staining of the particles.

In one embodiment, the particles of core material, after being treated with the organic material, are opaque.

In one embodiment, the particles of core material, after being with the organic material, are substantially non-abrasive and, thus, reduce wear on production equipment.

In one embodiment, the moisture of content of the core material, after being treated with the organic material, is less than about 0.3%.

In one embodiment, the particles of core material, after being coated with the organic material, have a bulk density from about 90 to about 110 pounds per cubic feet. In another embodiment, the bulk density of the treated particles is from about 60 to about 95 pounds per cubic feet.

In one embodiment, the particles of treated core material have a round to blocky shape with an average aspect ratio less than about 4.

In one embodiment, the particles of treated core material have improved adhesive properties (when compared to the untreated particles), improved crush resistance, improved u.v. resistance.

In one embodiment, the particles of treated core material have a reduced tendency to produce dust when handled as compared to the particles of untreated core material.

In one embodiment, the particles have a reflectance so that a substantial portion of incident electromagnetic radiation hitting the particles is reflected than absorbed.

What is claimed is:

1. A mineral composition comprised of at least 90 weight percent of roofing granules, wherein said roofing granules comprise at least 40 weight percent of calcium carbonate, have a hardgrove grindability index of less than 70, contain less than 1.0 percent of particles smaller than 250 microns, contain less than 1.0 percent of particles greater than 2380 microns, contain from about 2 to about 10 percent of particles greater than 1,680 microns, contain less than 2 percent of particles less than 40 microns, and have a Hunter L value of from about 20 to about 30.

2. The mineral composition as recited in claim 1, wherein said roofing granules comprise at least 80 weight percent of calcium carbonate.

3. The mineral composition as recited in claim 1, wherein said roofing granules comprise a coating of oil.

4. The mineral composition as recited in claim 1, wherein said oil is napthenic mineral oil.

5. A mineral composition comprised of at least 90 weight percent of roofing granules, wherein:
(a) said roofing granules comprise at least 40 weight percent of calcium carbonate,
(b) said roofing granules have a hardgrove grindability index of less than 70,
(c) said roofing granules are comprised of an inorganic core and, bonded to said inorganic core, a sheath comprised of organic material.

6. The mineral composition as recited in claim 5, wherein said roofing granules have a Hardgrove grindability index of less than about 60.

7. The mineral composition as recited in claim 5, wherein said roofing granules are impermeable to the passage of water.

8. The mineral composition as recited in claim 5, wherein said roofing granules are opaque.

9. A process for preparing a mineral composition comprised of roofing granules, comprising the steps of providing inorganic particles, contacting such inorganic particles with an organic material, and heating the inorganic particles contacted with said organic material to bond said organic material to said particles.
